(19) United States
(12) Patent Application Publication
(10) Pub. No.: US 2025/0275003 A1
(43) Pub. Date: Aug. 28, 2025

(54) COMMUNICATION APPARATUS AND COMMUNICATION METHOD FOR ENHANCED CLIENT DISCOVERY

(71) Applicant: Panasonic Intellectual Property Corporation of America, Torrance, CA (US)

(72) Inventors: Rojan CHITRAKAR, Singapore (SG); Yoshio URABE, Nara (JP); Hiroyuki MOTOZUKA, Kanagawa (JP)

(21) Appl. No.: 18/858,673

(22) PCT Filed: Mar. 6, 2023
(86) PCT No.: PCT/SG2023/050134

§ 371 Date: Oct. 21, 2024

(30) Foreign Application Priority Data
Apr. 27, 2022 (SG) 10202204497X
May 18, 2022 (SG) 10202205228T

(51) Int. Cl. H04W 76/15; H04W 48/16

(52) U.S. Cl. CPC H04W 76/15; H04W 48/16

(57) ABSTRACT

The present disclosure provides a communication apparatus and a communication method for enhanced client discovery, the communication apparatus comprising: circuitry, which, in operation, is configured to generates a first frame; a transmitter, which, in operation, transmits the first frame to a second communication apparatus to request for information of a third communication apparatus.

### TECHNICAL FIELD

The present disclosure relates to communication apparatuses and methods for client discovery, and more particularly for enhanced client discovery.

### BACKGROUND

A wireless local area network (WLAN) sensing is under development by Institute of Electrical and Electronics Engineers (IEEE) 802.11bf Task Group. In the task group, Sensing by Proxy (SBP), which enables a client to obtain sensing measurement using multiple radio links, is proposed, but the details of the protocol/procedure to obtain information of one or more non-access-point (non-AP) stations (STAs) has not been discussed. Meanwhile, Multi-Link Operation (MLO)/Multi-Link Device (MLD) specification, where multiple stations can be affiliated with an MLD, is under development by IEEE 802.11be Task Group.

While a whole house/office Wi-Fi coverage with multiple APs is very common these days, blindly measuring and reporting all possible links in the SBP reporting phase will cause a big overhead in the Wi-Fi link used for the reporting. In addition, an SBP initiator may have limited to no knowledge of the potential links for sensing measurements, for example, in the cases of a link between an AP (or an AP MLD) with other non-AP STAs (other non-AP MLDs) and a link between a STA associated with an AP (or a non-AP MLD associated with an AP MLD) and other STAs/APs. Such problem can be generalized as client discovery problems.

There is thus a need for communication apparatuses and methods for enhanced client discovery that provide feasible technical solutions to address the issues, more particularly, to enable a non-AP STA (or non-AP MLD) to obtain information about potential links from an AP (or AP MLD), for example the non-AP MLD (or non-AP MLD) being an SBP initiator that needs to obtain information about potential links from an AP (or AP MLD) in order to make a proper request for SBP procedure.

Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for enhanced client discovery in wireless network.

In a first aspect, the present disclosure provides a first communication apparatus comprising: circuitry, which, in operation, is configured to generate a first frame; a transmitter, which, in operation, transmits the first frame to a second communication apparatus to request for information of a third communication apparatus.

In a second aspect, the present disclosure provides a second communication apparatus comprising: a receiver, which, in operation, receives a request frame from a first communication apparatus requesting for information of a third communication apparatus; circuitry, which, in operation, is configured to process the request frame and generate a response frame comprising the information; and a transmitter, which in operation, transmits the response frame to the first communication apparatus.

In a third aspect, the present disclosure provides a communication method implemented by a first communication apparatus comprising: generating a first frame; and transmitting the first frame to a second communication apparatus to request for information of a third communication apparatus.

In a fourth aspect, the present disclosure provides a communication method implemented by a second communication apparatus comprising: receiving a request frame from a first communication apparatus requesting for information of a third communication apparatus; processing the request frame; generating a response frame comprising the information; and transmitting the response frame to the first communication apparatus.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 depicts a schematic diagram illustrating a single-user (SU) communication between an access point (AP) and a station (STA) in a MIMO (multiple-input multiple-output) wireless network.

FIG. 2 depicts a schematic diagram illustrating downlink multi-user (MU) communication between an AP and multiple STAs in a MIMO wireless network.

FIG. 3 depicts a schematic diagram illustrating a trigger-based (TB) uplink MU communication between an AP and multiple STAs in a MIMO wireless network.

FIG. 4 depicts a schematic diagram illustrating communications between a STA (client 0) and an AP for a basic SBP procedure.

FIG. 5 depicts a schematic diagram illustrating three wireless links between an AP MLD and a non-AP MLD.

FIG. 6A shows a format of a neighbor report element.

FIG. 6B shows a format of a reduced neighbor report element.

FIG. 6C shows a format of the Neighbor AP information field in FIG. 6B.

FIG. 7 shows a schematic diagram showing a floor plan and devices located therein.

FIG. 8 depicts a schematic view of a communication apparatus according to the present disclosure.

FIG. 9 shows a flowchart illustrating a communication method implemented by a first communication apparatus according to various embodiments of the present disclosure.

FIG. 10 shows a flowchart illustrating a communication method implemented by a second communication apparatus such as an SBP responder according to various embodiments of the present disclosure.

FIG. 11 shows a flowchart illustrating example level 1 and level 2 enhanced client discovery procedures between a non-AP STA and an AP.

FIG. 12 shows a flowchart illustrating example level 1 and level 2 enhanced client discovery procedures between a non-AP MLD and an AP MLD.

FIG. 13 depicts a flowchart illustrating an enhanced client discovery procedure between an AP and a non-AP STA according to the first embodiment of the present disclosure.

FIG. 14 depicts a flowchart illustrating an enhanced client discovery procedure between an AP MLD and a non-AP MLD according to the first embodiment of the present disclosure.

FIG. 15 shows an example visualization of level 1 and level 2 enhanced client discovery results.

FIG. 16 shows an example format of a multi-link element (MLE) used for basic discovery according to an embodiment of the present disclosure.

FIG. 17 shows an example format of a Multi-Link Load Element used by an AP MLD for basic discovery according to an embodiment of the present disclosure.

FIG. 18 shows an example format of a Protected Client Discovery Query frame used for Level 1 Client Discovery Query according to embodiments of the present disclosure.

FIG. 19 shows an example format of a Protected Authorization Validation Request frame according to an embodiment of the present disclosure.

FIG. 20 shows an example format of a Protected Authorization Validation Response frame according to an embodiment of the present disclosure.

FIG. 21 shows an example format of a level 1 Client Discovery Response frame according to an embodiment of the present disclosure.

FIG. 22 shows another example format of a level 1 Client Discovery Response frame according to an embodiment of the present disclosure.

FIG. 23 shows an example format of the MLD Info Element field of the Protected Client Discovery Response frame depicted in FIG. 22.

FIG. 24 shows an example format of a Protected Client Discovery Query frame used for Level 2 Client Discovery Query according to an embodiment of the present disclosure.

FIG. 25 shows an example format of a level 2 Client Discovery Response frame according to an embodiment of the present disclosure.

FIG. 26 shows another example format of a level 2 Client Discovery Response frame according to an embodiment of the present disclosure.

FIG. 27 shows an example format of the MLD Info Element field of the Protected Client Discovery Response frame depicted in FIG. 26.

FIG. 28 shows a flowchart illustrating a Level 3 Client Discovery procedure triggered by an AP according to an embodiment of the present disclosure.

FIG. 29 shows a flowchart illustrating a Level 3 Client Discovery procedure triggered by an AP MLD according to an embodiment of the present disclosure.

FIG. 30 shows a schematic diagram illustrating a multi-AP network deployment according to embodiments of the present disclosure.

FIG. 31 shows a schematic diagram illustrating a tunneled enhanced client discovery procedure according to the third embodiment of the present disclosure.

FIG. 32 shows a flowchart illustrating a tunneled enhanced client discovery procedure between a non-AP STA1 and non-AP STA2 according to the third embodiment of the present disclosure.

FIG. 33A shows an example format of an Enhanced Client Discovery Ethertype 89-0d Data frame according to the third embodiment of the present disclosure.

FIG. 33B shows an example content of the Payload field illustrated in FIG. 33A according to the embodiment.

FIG. 34 shows an example configuration of a communication apparatus.

FIG. 35 shows another example configuration of a communication apparatus.

Skilled artisans will appreciate that elements in the figures are illustrated for simplicity and clarity and have not necessarily been depicted to scale. For example, the dimensions of some of the elements in the illustrations, block diagrams or flow charts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for enhanced client discovery, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (AP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N×M MIMO network system, N is the number of transmitter antennas, M is the number of receiver antennas, and N may or may not be equal to M. For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams. According to various embodiments, the term “spatial stream” may be used interchangeably with the term “space-time stream” (or STS).

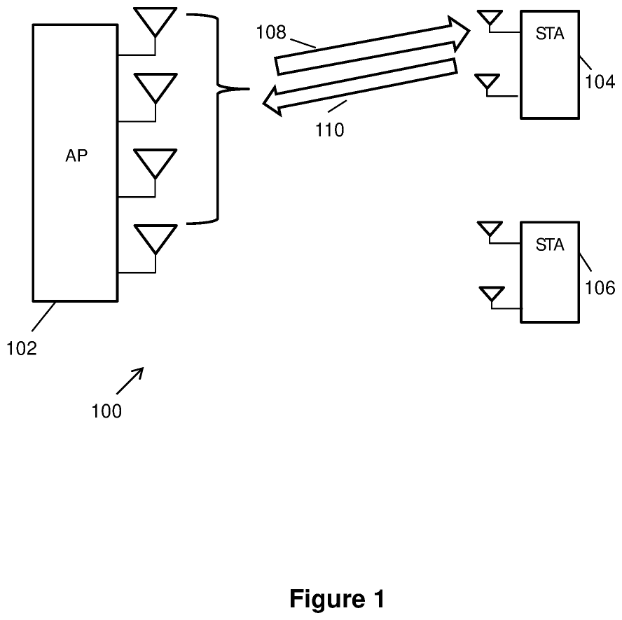

FIG. 1 depicts a schematic diagram illustrating a SU communication 100 between an AP 102 and a STA 104 in a MIMO wireless network. As shown, the MIMO wireless network may include one or more STAs (e.g., STA 104, STA 106, etc.). If the SU communication 100 in a channel is carried out over whole channel bandwidth, it is called full bandwidth SU communication. If the SU communication 100 in a channel is carried out over a part of the channel bandwidth (e.g., one or more 20 MHz subchannels within the channel is punctured), it is called punctured SU communication. In the SU communication 100, the AP 102 transmits multiple space-time streams using multiple antennas (e.g., four antennas as shown in FIG. 1) with all the space-time streams directed to a single communication apparatus, i.e. the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1, in the SU communication 100, the STA 104 may transmit multiple space-time streams using multiple antennas (e.g., two antennas as shown in FIG. 1) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1 enables both uplink and downlink SU transmissions in a MIMO wireless network.

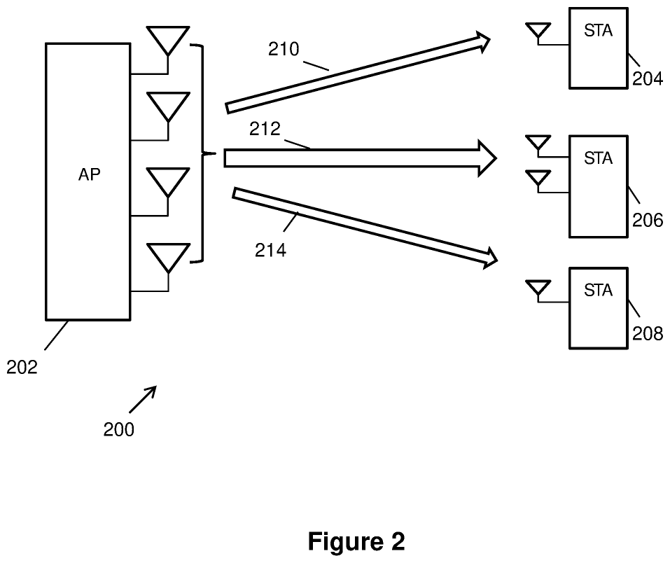

FIG. 2 depicts a schematic diagram illustrating a downlink MU (multiple-user) communication 200 between an AP 202 and multiple STAs 204, 206, 208 in a MIMO wireless network. The MIMO wireless network may include one or more STAs (e.g., STA 204, STA 206, STA 208, etc.). The MU communication 200 can be an OFDMA (orthogonal frequency division multiple access) communications or a MU-MIMO communication. For an OFDMA communication in a channel, the AP 202 transmits multiple streams simultaneously to the STAs 204, 206, 208 in the network at different resource units (RUs) within the channel bandwidth. For a MU-MIMO communication in a channel, the AP 202 transmits multiple streams simultaneously to the STAs 204, 206, 208 at same RU(s) within the channel bandwidth using multiple antennas via spatial mapping or precoding techniques. If the RU(s) at which the OFDMA or MU-MIMO communication occurs occupy whole channel bandwidth, the OFDMA or MU-MIMO communications is called full bandwidth OFDMA or MU-MIMO communications. If the RU(s) at which the OFDMA or MU-MIMO communication occurs occupy a part of channel bandwidth (e.g., one or more 20 MHz subchannel within the channel is punctured), the OFDMA or MU-MIMO communication is called punctured OFDMA or MU-MIMO communications. For example, two space-time streams may be directed to the STA 206, another space-time stream may be directed to the STA 204, and yet another space-time stream may be directed to the STA 208. For the sake of simplicity, the two space-time streams directed to the STA 206 are illustrated as a grouped data transmission arrow 212, the space-time stream directed to the STA 204 is illustrated as a data transmission arrow 210, and the space-time stream directed to the STA 208 is illustrated as a data transmission arrow 214.

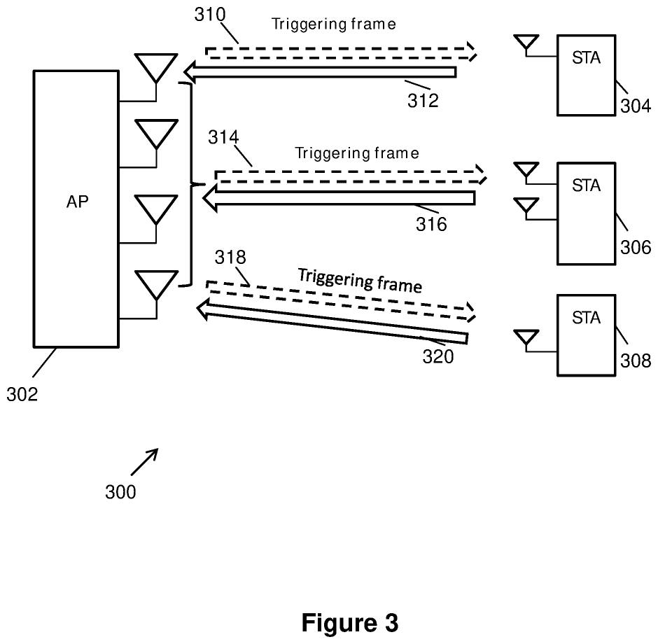

To enable uplink MU transmissions, trigger-based communication is provided to the MIMO wireless network. In this regard, FIG. 3 depicts a schematic diagram illustrating a trigger-based (TB) uplink MU communication 300 between an AP 302 and multiple STAs 304, 306, 308 in a MIMO wireless network.

Since there are multiple STAs 304, 306, 308 respectively participating in the trigger-based uplink MU communication, the AP 302 needs to coordinate simultaneous transmissions of multiple STAs 304, 306, 308.

To do so, as shown in FIG. 3, the AP 302 transmits triggering frames 310, 314, 318 simultaneously to STAs 304, 306, 308 respectively to indicate user-specific resource allocation information (e.g., the number of space-time streams, a starting STS number and the allocated RUs) that each STA can use. In response to the triggering frames, STAs 304, 306, 308 may then transmit their respective space-time streams simultaneously to the AP 302 according to the user-specific resource allocation information indicated in the triggering frames 310, 314, 318. For example, two space-time streams may be directed to the AP 302 from STA 306, another space-time stream may be directed to the AP 302 from STA 304, and yet another space-time stream may be directed to the AP 302 from STA 308. For the sake of simplicity, the two space-time streams directed to the AP 302 from STA 306 are illustrated as a grouped data transmission arrow 316, the space-time stream directed to the AP 302 from STA 304 is illustrated as a data transmission arrow 312, and the space-time stream directed to the AP 302 from STA 308 is illustrated as a data transmission arrow 320.

Due to packet/PPDU (physical layer protocol data unit) based transmission and distributed MAC (medium access control) scheme in 802.11 WLAN, time scheduling (e.g., TDMA (time division multiple access)-like periodic time slot assignment for data transmission) does not exist in 802.11 WLAN. Frequency and spatial resource scheduling is performed on a packet basis. In other words, resource allocation information is on a PPDU basis.

According to various embodiments, WLAN supports non-trigger-based communications as illustrated in FIG. 1 and trigger-based communications as illustrated in FIG. 2. In non-trigger-based communications, a communication apparatus transmits a PPDU to one other communication apparatus or more than one other communication apparatuses in an unsolicited manner. In trigger-based communications, a communication apparatus transmits a PPDU to one other communication apparatus or more than one other communication apparatuses only after a soliciting triggering frame is received.

According to the present disclosure, the term “sensing initiator” refers to a device which initiates a sensing session with a STA (herein referred to as “client”) and requests for a sensing result from the STA. The term “sensing responder” is a STA which responds to the sensing initiator and participates in the sensing session. In various embodiments below, unless otherwise stated, the term “initiator” and “responder” refer to “sensing initiator” and “sensing responder”, respectively. Typically (e.g., in Trigger Based (TB) sensing measurements), the initiator is an AP, while the responders are non-AP STAS; however this need not always be the case and at times non-AP STAs can also be the initiator, and an AP can be a responder (e.g., in Non-TB sensing measurements, or Fine Timing Measurements (FTM)/Ranging).

In contrast to “sensing initiator” and “sensing responder”, the term “Sensing By Proxy (SBP) initiator” refers to a STA which initiate an SBP procedure and requests a device (e.g., AP or sensing initiator) to be a proxy sensing initiator to initiate a sensing session and request for a sensing result from another STA (e.g., the device's client) on its behalf. The term “SBP responder” refers to a device which responds to the SBP initiator and agrees to participate in the SBP procedure to be a proxy sensing initiator. It is noted that an SBP initiator can be a sensing responder or one of multiple sensing responders of an SBP responder (sensing initiator).

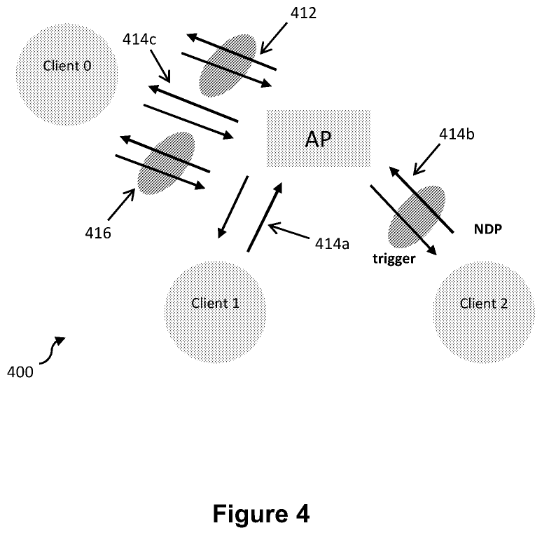

As mentioned earlier, SBP, which enables a client to obtain sensing measurement using multiple radio links, is introduced in IEEE 802.11 bf. FIG. 4 depicts a schematic diagram 400 illustrating communications between a STA (client 0) and an AP for a basic SBP procedure. According to the basic concept, a Sensing by Proxy procedure includes an SBP procedure setup, a sensing measurement, an SBP procedure reporting and an SBP procedure termination. During SBP procedure setup, a client (e.g., client 0) requests the AP to obtain sensing measurements. The AP is configured to act as a proxy-initiator for the requesting client. In various embodiments illustrated in the present disclosure, such requesting client is referred to as SBP requesting STA or SBP Initiator while the AP is referred to proxy AP or SBP Responder. The proxy is established by exchanging SBP request/response frames 412 between the SBP Initiator and the SBP Responder. The AP then performs sensing measurement with one or more clients (e.g., clients 1 and 2), for example, by exchanging measurement setup request/response frames to establish sessions and/or measurement report frame 414a, 414b during measurement instance(s). In the FIG. 4 example, the SBP Initiator is one of the clients, and the AP may also perform sensing measurement with the SBP Initiator by exchanging the relevant frames 414c. During SBP procedure Reporting, the AP which obtained the client's measurement reports then reports them to the SBP Initiator, for example, by sending an SBP report frame 414. After the SBP procedure Reporting, the SBP procedure may be terminated at any time by either the SBP Initiator or the SBP Responder by transmitting an SBP Termination frame (not shown).

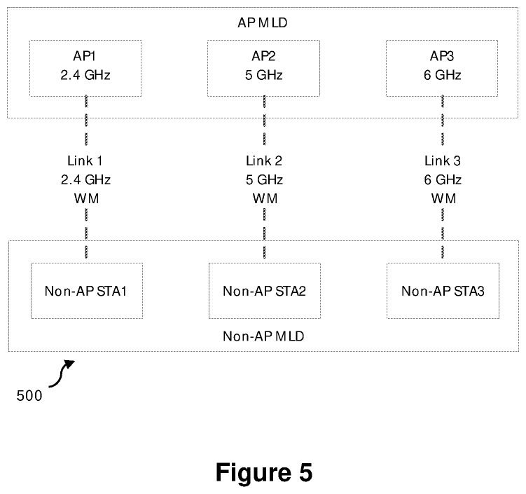

In addition, 802.11be has introduced the concept of Multi-Link Device (MLD), where multiple stations can be affiliated with an MLD, allowing seamless communication between two MLDs over multiple wireless links. FIG. 5 depicts a schematic diagram 500 illustrating three wireless links between an AP MLD and a non-AP MLD. In particular, three APs (AP1, AP2, AP3) operating in 2.4 GHZ, 5 GHZ and 6 GHz frequencies respectively are affiliated with the AP MLD and three non-AP STAs (non-AP STA1, non-AP STA2, non-AP STA3) operating in 2.4 GHZ, 5 GHz and 6 GHz frequencies respectively are affiliated with the non-AP MLD. The AP1 and non-AP STA1 operating in 2.4 GHz frequency communicate with each other through Link 1; the AP2 and non-AP STA2 operating in 5 GHz frequency communicate with each other through Link 2; and the AP3 and non-AP STA3 operating in 6 GHz frequency communication with each other through Link 3.

Furthermore, according to 802.11be_D1.5, an EHT AP shall have dot11MultiLinkActivated set to true and shall be affiliated with an AP MLD, and the EHT AP and its affiliated AP MLD follow the rules defined in 35.3 (Multi-link operation). This means that all EHT APs are affiliated with an AP MLD and there are no standalone EHT APs. In other words, MLDs, in context of EHT WLAN, will be involved in SBP (e.g., as an SBP initiator or SBP responder). However, there have been no related discussion in 11bf in this regard yet.

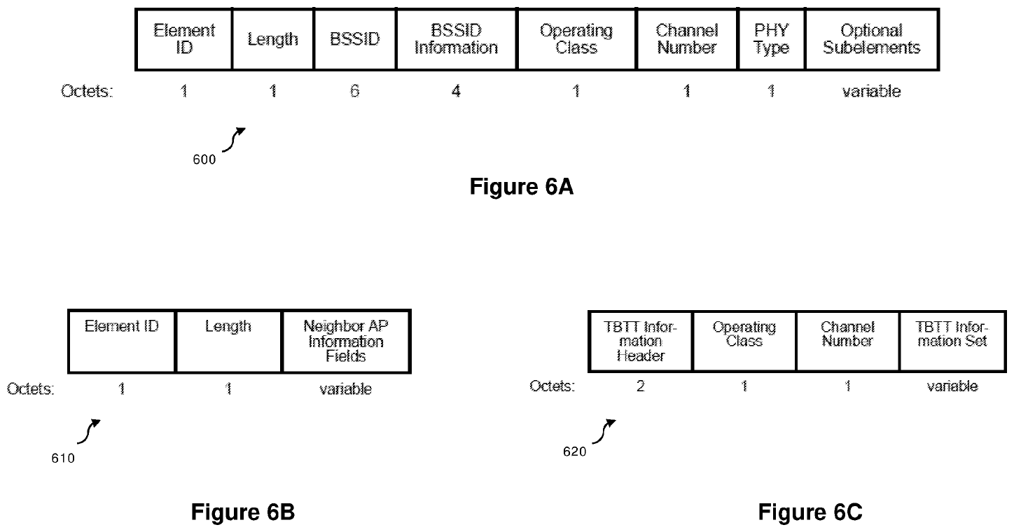

With regards to obtaining information of APs, aside from advertising its own information, IEEE 802.11 provides containers (e.g., signal frames) for an AP to advertise information of its neighbor APs. For example, an AP may include a Neighbor Report element, or a Reduced Neighbor Report element in its Beacon, Probe Response frames etc. to advertise information of its neighbor APs. FIG. 6A shows a format of a neighbor report element 600. The Neighbor report element comprises an Element Identifier (ID) field, a Length field, a Basic Service Set ID (BSSID) Information field, an Operating Class field, a Channel Number field, a PHY Type field and Optional Subelements, consisting of 1, 1, 6, 5, 1, 1, 1 and a variable number of octets respectively.

FIG. 6B shows a format of a reduced neighbor report element 610. The reduced neighbor report element 610 comprises an element ID field, a Length field and Neighbor AP Information Fields 620, consisting of 1, 1 and a variable number of octets respectively. FIG. 6C shows a format of the Neighbor AP information field 620 in FIG. 6B. Each of the Neighbor AP information fields 620 may comprise a Target Beacon Transmission Time (TBTT) Information Header field, an Operating Class field, a Channel Number field and a TBTT Information Set field, consisting of 2, 1,1 and a variable number of octets respectively. However. These report elements 610, 620 are limited to advertisement and discovery of APs.

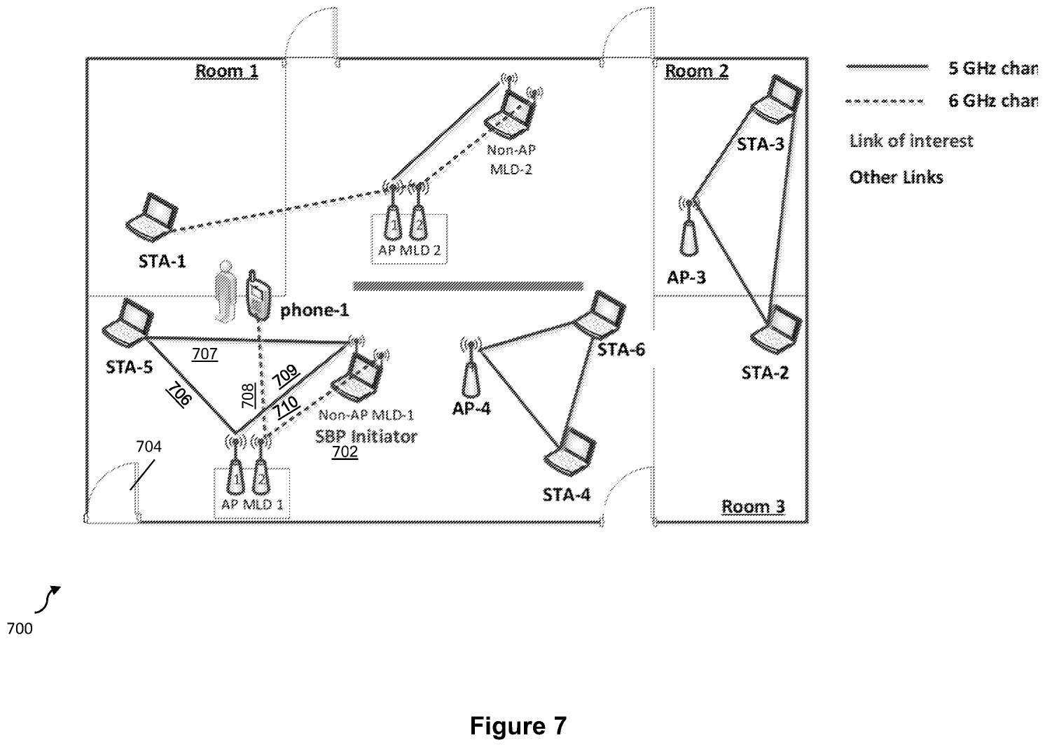

As mentioned earlier, there are client discovery problems in SBP procedure. As whole house/office/building/entity coverage with Multi-AP Wi-Fi (e.g., with Mesh Wi-Fi or enterprise Wi-Fi network) is very common these days, blindly measuring and reporting all possible links in the SBP reporting phase will cause a big overhead in the Wi-Fi link used for reporting. FIG. 7 shows a schematic diagram 700 showing a floor plan of an office and devices located therein. In this figure, non-AP MLD-1 is an SBP Initiator 702 configured to perform human presence detection or tracking of persons within the office premise, e.g., persons entering the floor from any of the entrances, e.g., the door 704. There may be 15 possible links between the devices, as illustrated using lines between devices, but only 5 links 706-710 (among STA-5, phone-1, AP MLD1 and non-AP MLD-1) may be of interest for the human tracking sensing application focus on human presence detection in the vicinity of the door 704.

In addition, an SBP Initiator typically has limited or no knowledge of the potential links for sensing measurement, for example, in the cases of a link between an AP (or an AP MLD) with other non-AP STAs (other non-AP MLDs) and a link between a STA associated with an AP (or a non-AP MLD associated with an AP MLD) and other STAs/APs. Blindly requesting sensing measurements on all possible links will cause huge overhead in the wireless networks, where in fact the sensing measurement in many links may be of little or no interest to the sensing application. While WLAN sensing is taken here as an example where information of other non-AP STAs would be useful to another non-AP STA, the utility is not limited to sensing applications and can benefit many other applications, such as, network visualization/trouble shooting, load balancing etc.

The present disclosure illustrates an enhanced client discovery that enables a non-AP STA (or non-AP MLD) to obtain information about potential links from an AP (or AP MLD). The links may be AP to STA links (e.g., Initiator-to-Responder (I2R) or Responder-to-Initiator (R2I)) or STA to STA links (e.g., Responder-to-Responder (R2R)). The present disclosure also seeks to propose related signalling and frame format for the enhanced client discovery.

It is noted that, various embodiments below use SBP to illustrate the enhanced client discovery to address the client discovery problems and issues. It is appreciated that such enhanced client discovery that enables a non-AP STA (or non-AP MLD) to have access to information about other non-AP STAs can be applied to and benefit many other applications with other similar client discovery problems such as SBP setup wireless network visualization for administrators for network planning and troubleshooting, Wi-Fi load balancing.

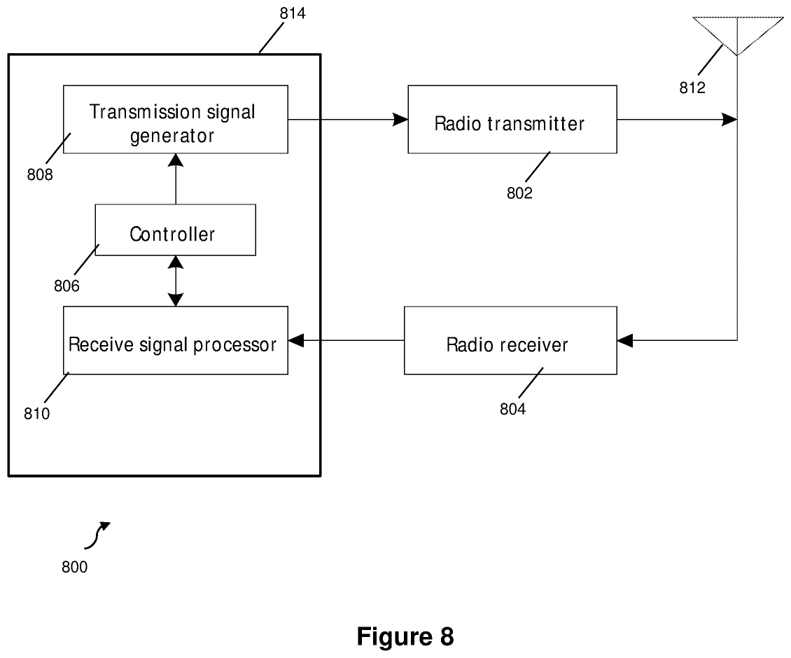

FIG. 8 depicts a schematic view of a communication apparatus 800 according to the present disclosure. The communication apparatus 800 may also be implemented as a sensing initiator, a sensing responder, an SBP initiator or an SBP responder.

As shown in FIG. 8, the communication apparatus 800 may include circuitry 814, at least one radio transmitter 802, at least one radio receiver 804, and at least one antenna 812 (for the sake of simplicity, only one antenna is depicted in FIG. 8 for illustration purposes). The circuitry 814 may include at least one controller 806 for use in software and hardware aided execution of tasks that the at least one controller 806 is designed to perform, including control of communications with one or more other communication apparatuses in a MIMO wireless network. The circuitry 814 may further include at least one transmission signal generator 808 and at least one receive signal processor 810. The at least one controller 806 may control the at least one transmission signal generator 808 for generating MAC frames and PPDUs) to be sent through the at least one radio transmitter 802 to one or more other communication apparatuses, wherein the MAC frames, for example, may be Client Discovery Query/Request/Response frame, Polling Trigger frame, Sounding Trigger frame, NFRP Trigger frame; and the PPDU, for example, may be PPDUs used for non-trigger-based communications, PPDUs used for trigger-based sounding procedure, PPDUs used for trigger-based downlink transmissions if the communication apparatus 800 is an AP, or PPDUs used for trigger-based uplink transmissions if the communication apparatus 800 is a STA. The at least one controller 806 may control the at least one receive signal processor 810 for processing MAC frames and PPDUs received through the at least one radio receiver 804 from the one or more other communication apparatuses under the control of the at least one controller 806, wherein the MAC frames, for example, may be Client Discovery Query/Request/Response frame, Polling Trigger frame, Sounding Trigger frame, NFRP Trigger frame; and the PPDU, for example, may be PPDUs used for non-trigger-based communications, PPDUs used for trigger-based sounding procedure, PPDUs used for trigger-based uplink transmissions if the communication apparatus 800 is an AP, or PPDUs used for trigger-based downlink transmissions if the communication apparatus 800 is a STA. The at least one transmission signal generator 808 and the at least one receive signal processor 810 may be stand-alone modules of the communication apparatus 800 that communicate with the at least one controller 806 for the above-mentioned functions, as shown in FIG. 8. Alternatively, the at least one transmission signal generator 808 and the at least one receive signal processor 810 may be included in the at least one controller 806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 802, at least one radio receiver 804, and at least one antenna 812 may be controlled by the at least one controller 806.

The communication apparatus 800, when in operation, provides functions required for enhanced client discovery. For example, the communication apparatus 800 may be an SBP initiator, and the circuitry 814 (for example the at least one transmission signal generator 808 of the circuitry 814) may generate a first frame, and the at least one radio transmitter 802 may then transmit the first frame to an SBP responder to request for information of a sensing responder.

In an embodiment, where there are one or more potential sensing responders, the circuitry 814 may further generate a second frame, and the at least one radio transmitter 802 may then transmit the second frame to request for information of a particular potential sensing responder.

In another embodiment, the at least one radio receiver 804, may receive validation request frame to request for verification information indicating that the communication apparatus 800 is authorized to obtain the information of the sensing responder. The circuitry 814 (for example the at least one receive signal processor 810 and the at least one transmission signal generator 808 of the circuitry 814, respectively) may be configured to process and generate a validation response frame comprising the verification information. The at least one radio transmitter 802 may then transmit the validation response frame.

The communication apparatus 800 may be a sensing SBP responder, and the at least one radio receiver 804 receives a request frame from one non-AP STA, e.g., an SBP initiator requesting for information of another non-AP STA, e.g., a sensing responder. The circuitry 814 (for example the at least one receive signal processor 810 and the at least one transmission signal generator 808 of the circuitry 814, respectively) process the request frame and generate a response frame comprising the information. The at least one radio transmitter 802 may then transmit the response frame to the SBP initiator.

In one embodiment, the circuitry 814 (for example the at least one transmission signal generator 808 of the circuitry 814) may be configured to further generate a validation request frame to request for verification information indicating that the requesting non-AP STA, e.g., the SBP initiator is authorized to obtain the information of the target non-AP STA, e.g., the sensing responder. The at least one radio receiver 804 then receives a validation response frame comprising the verification information from the SBP initiator.

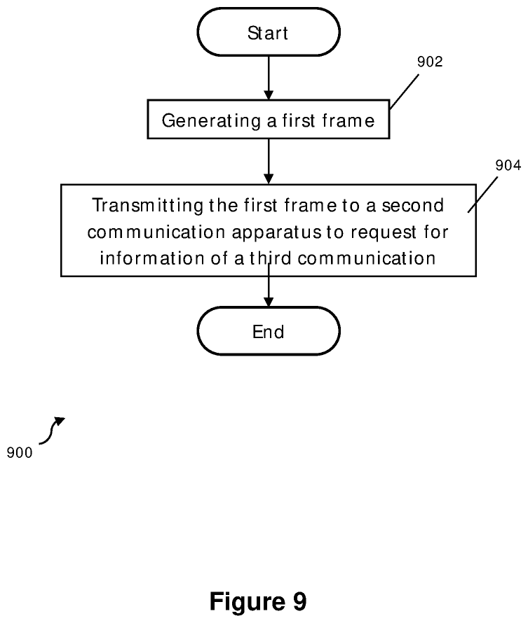

FIG. 9 shows a flowchart 900 illustrating a communication method implemented by a first communication apparatus such as an SBP initiator according to various embodiments of the present disclosure. In step 902, a step of generating a first frame is carried out. In step 904, a step of transmitting the first frame generated in step 902 to a second communication apparatus such as an SBP responder to request for information of a third communication such as a sensing responder is carried out.

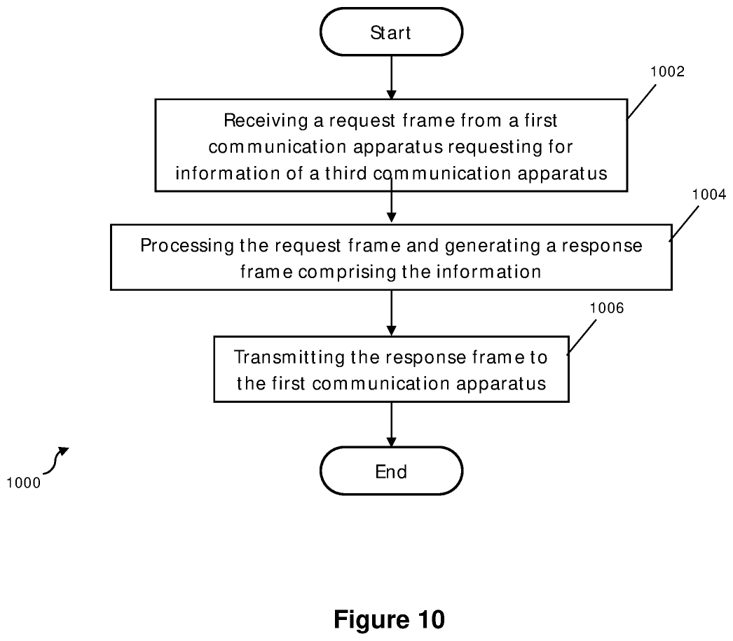

FIG. 10 shows a flowchart 1000 illustrating a communication method implemented by a second communication apparatus such as an SBP responder according to various embodiments of the present disclosure. In step 1002, a step of receiving a request from a first communication apparatus such as an SBP initiator for information of a third communication apparatus such as a sensing responder is caried out. In step 1004, a step of processing the request frame received in step 1002 and generating a response frame comprising the information is carried out. In step 1006, a step of transmitting the response frame generated in step 1004 to the first communication apparatus is carried out.

According to various embodiments of the present disclosure, an enhanced client discovery procedure consists of a client discovery query procedure and a client discovery response procedure, and there could be many levels of enhanced client discovery procedure. A non-AP STA, e.g., an SBP initiator may perform any one or more levels for client discovery.

For level 1 client discovery query, a non-AP STA requests an AP to provide a list of non-AP STAs (associated non-AP STAs and optionally unassociated non-AP STAs). In the request, the non-AP STA may optionally specify the Discovery criteria such as (i) STA capabilities (PHY version (11ax, 11be, etc), supported features (11bf, SBP, etc.), etc., (ii) Link metrics (minimum downlink/uplink received channel power indicator (RCPI)/receive signal strength indicator (RSSI), maximum data rate etc.). It is noted that the STA requesting the enhanced client discovery need not be associated with the AP.

For level 1 client discovery response, in response to a level 1 client discovery query, the AP provides information of a list (e.g., MAC addresses, or Association Identifiers (AID)) of all its associated non-AP STAs and optionally information (e.g., Unassociated Identifiers (UID)) of unassociated non-AP STAs that it has. If Discovery criteria is provided in the query, the AP may then provide a list of non-AP STAs that meet the Discovery criteria.

For level 2 client discovery query, a non-AP STA may request detailed information of a particular non-AP STA by indicating its ID (e.g., MAC Address, or Association Identifier (AID) or Unassociated Identifier (UID)) in the query. Such ID may be obtained from through level 1 client discovery query and response steps. In the request, the requesting non-AP STA may indicate whether information about other devices which are within radio range of the particular indicated non-AP STA. It should be noted that the non-AP STA requesting the enhanced client discovery need not be associated with the AP.

For level 2 client discovery response, in response to level 2 client discovery query, the AP provides detailed information about the indicated non-AP STA such as (i) STA capabilities (PHY version (11ax, 11be, etc), supported features (11bf, SBP, etc.), etc., (ii) Link metrics (minimum downlink/uplink RCPI/RSSI, maximum data rate etc.) and (iii) a list of other non-AP STAs and APs within radio range of the indicated non-AP STA if it is so requested in the query.

There are also level 3 client discovery. More information on level 3 client discovery query and response will be elaborated below.

Essentially, regardless of its level, this enhanced client discovery procedure described in the present disclosure is different from the existing neighbor AP discovery procedure illustrated above and FIGS. 6A-C, whose aim is advertisement and discovery of APs. The primary target of the enhanced client discovery described in the present disclosure relates to discovery of non-AP STAs.

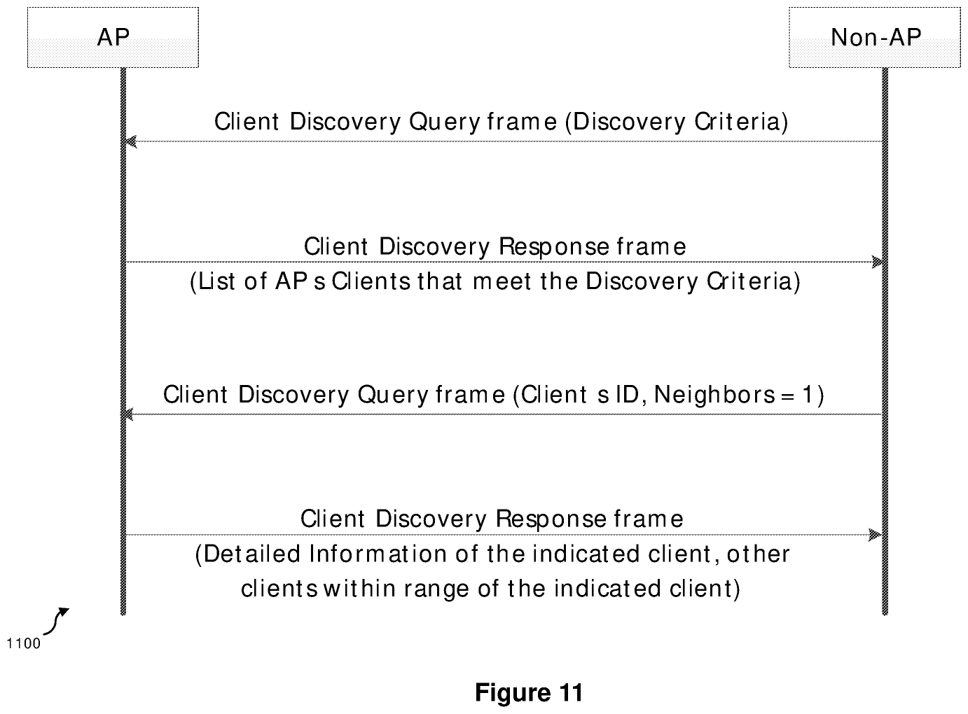

FIG. 11 shows a flowchart 1100 illustrating example level 1 and level 2 enhanced client discovery procedures between a non-AP STA and an AP. The non-AP STA may first perform a level 1 enhanced client discovery by transmitting a Client Discovery Query frame specifying Discovery Criteria to the AP. The target client (i.e., non-AP STA or sensing responder) is not specified. The AP then transmits a Client Discovery Response frame with a list of AP's clients that meet the discovery criteria. With the information of the AP's client, the non-AP STA may then perform a level 2 enhanced client discovery by transmitting another Client Discovery Query frame specifying a client's ID. A field (in this case neighbor field) is set to 1 to indicate that information about the specified client's neighbor clients/devices (AP or non-AP), i.e., clients/devices located within a radio range of the specified client, is also requested. The AP then transmits another Client Discovery Response frame comprising detailed information of the specified client and other clients within the radio range of the specified client. Optionally, Discovery criteria for the neighboring devices/clients such as (i) STA capabilities (PHY version (11ax, 11be, etc), supported features (11bf, SBP, etc.), etc., and (ii) Link metrics (minimum downlink/uplink RCPI/RSSI, maximum data rate etc.) may also be included in the Client Discovery Query frame such that the AP may only transmit detailed information of the specified client and other clients that are within the radio range of the specified client and meet the Discovery Criteria.

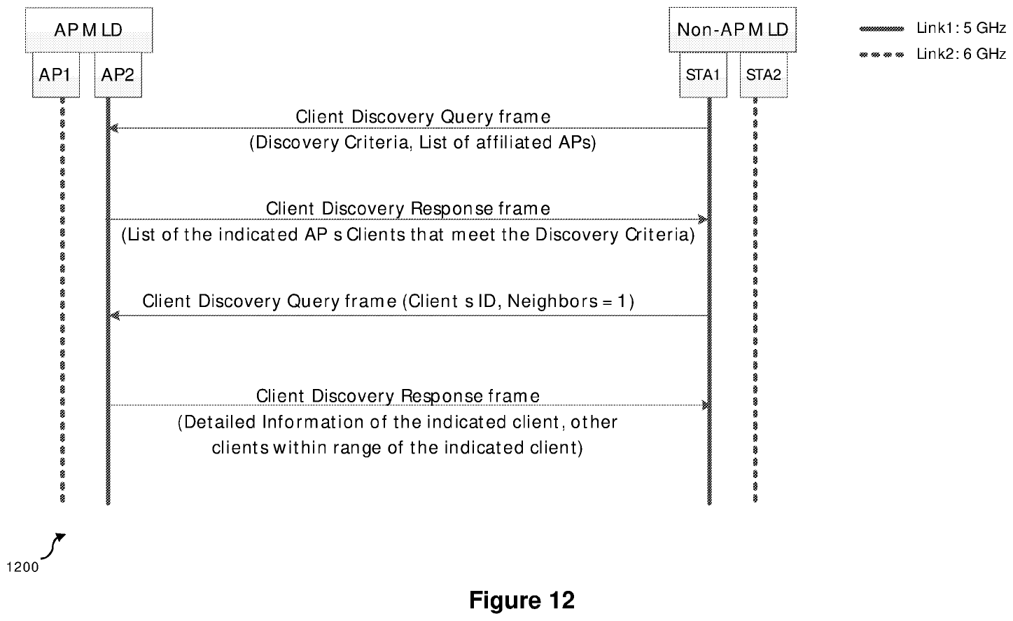

FIG. 12 shows a flowchart 1200 illustrating example level 1 and level 2 enhanced client discovery procedures between a non-AP MLD and an AP MLD. For enhanced client discovery procedure between MLDs, the Client Discovery Query may indicate one or more affiliated AP of the AP MLD (or BSSs provided by the AP MLD) and addressed to any one of affiliated AP of the AP MLD over any one link of the AP MLD.

The Client Discovery Query frame, beside Discovery criteria, may also indicate a list of affiliated APs of the MLD to perform the enhanced client discovery procedure. In this case, STA1, which is affiliated with the non-AP MLD, may perform a level 1 enhanced client discovery by transmitting a Client Discovery Query frame to AP2, which is affiliated with the AP MLD. The Client Discovery Query frame may specify Discovery Criteria and indicate a list of affiliated APs (e.g., AP1, AP2). The AP then transmits a Client Discovery Response frame comprising a list of the indicated AP's non-MLD clients (e.g., AP1's client, AP2′ clients), as well as the non-AP MLDs associated with the AP MLD and that meet the Discovery Criteria.

With the information of the AP's client, the non-AP STA may then perform a level 2 enhanced client discovery by transmitting another Client Discovery Query frame specifying a client's ID to the AP MLD (via AP2) again. The specific non-AP STA or non-AP MLD may be associated with another AP of the AP MLD (e.g., AP1's client). A field (in this case neighbor field) is set to 1 to indicate that information about the specified client's neighbor clients/devices (AP or non-AP) located within a radio range of the specified client is also requested. The AP MLD (via an affiliated AP) then transmits another Client Discovery Response frame comprising detailed information of the specified client and other clients within the radio range of the specified client.

In the following paragraphs, a first embodiment of the present disclosure where an enhanced client discovery procedure between an AP and a non-AP STA (or an AP MLD and a non-AP MLD) is described.

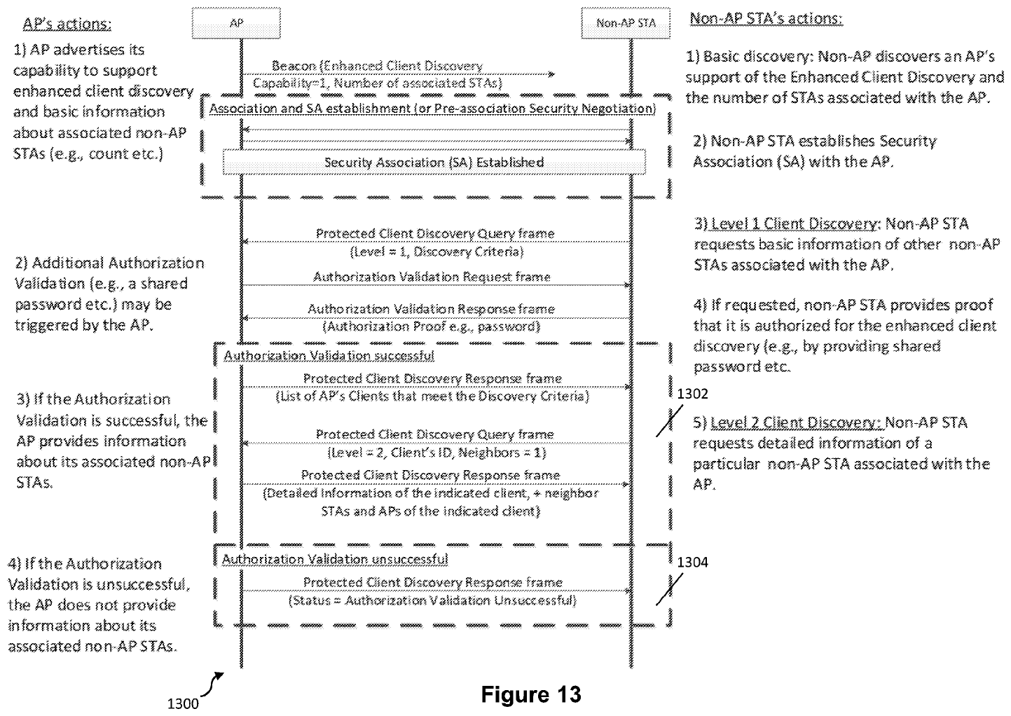

FIG. 13 depicts a flowchart 1300 illustrating an enhanced client discovery procedure between an AP and a non-AP STA according to the first embodiment of the present disclosure. The AP advertises its capability to support enhanced client discovery and basic information about associated non-AP STAs (e.g., count/number of associated STAs etc.) using a beacon frame. The non-AP STA may perform a basic discovery and discover an AP's support of the Enhanced Client Discovery and the number of STAs associated with the AP. Subsequently, the non-AP STA may perform association and security association (SA) establishment (or pre-association security negotiation) with the AP.

The non-AP STA then transmits a Protected Client Discovery Query frame to request for basic information of other non-AP STAs associated with the AP. The Protected Client Discovery Query frame has its level field set to 1 to indicate a level 1 Enhanced Client Discovery Query and includes Discovery Criteria. The AP may perform additional authorization validation to request for verification information or authorization proof (e.g., shared password) that the non-AP STA is authorized to obtain the information of the other non-AP STAs by transmitting an Authorization Validation Request frame back to the non-AP STA. The non-AP STA then, in response, transmits an Authorization Validation Response frame comprising the verification information or authorization proof (e.g., password) to prove that it is authorized for the enhanced client discovery to obtain the information of the other non-AP STAs.

If the Authorization Validation is successful, steps shown in block 1302 are carried out; otherwise step shown in block 1304 is carried out. In particular, if the Authorization Validation is successful, the AP then transmits a Protected Client Discovery Response frame comprising information of a list of AP's clients that meet the Discovery Criteria to the non-AP STA. Additionally, the non-AP STA may further transmit a second Protected Client Discovery Query frame to the AP to request for detailed information of a particular non-AP STA (client) associated with the AP. This second Protected Client Discovery Query frame has its level field set to 2 to indicate a level 2 Enhanced Client Discovery Query, and indicates a client's ID to identify the non-AP STA (client) and has its neighbor field set to 1 to indicate information of neighboring devices/clients located within the range of the client.

Although not shown in the figure, upon reception of a Level 2 Client Discovery Query frame, the AP may trigger a neighbor client discovery request to each of its associated non-AP STAs to discover information of their neighboring STAs and APs. The AP then transmits a Protected Client Discovery Response frame back to the non-AP STA comprising detailed information of the indicated client and its neighboring STAs and APs of the indicated client.

If the Authorization Validation is unsuccessful, the AP does not provide information about its associated non-AP STAs, but instead will transmit a Protected Client Discovery Response frame with a status field indicating that the Authorization Validation was unsuccessful.

In one example, the exchange of the Authorization Validation Request/Response frame may be skipped if the AP has other means to verify the non-AP STA's authorization to obtain information about other non-AP STAs. For example, the AP may maintain a list of authorized devices, or it may consult with a list of authorized devices from a database on a server etc.

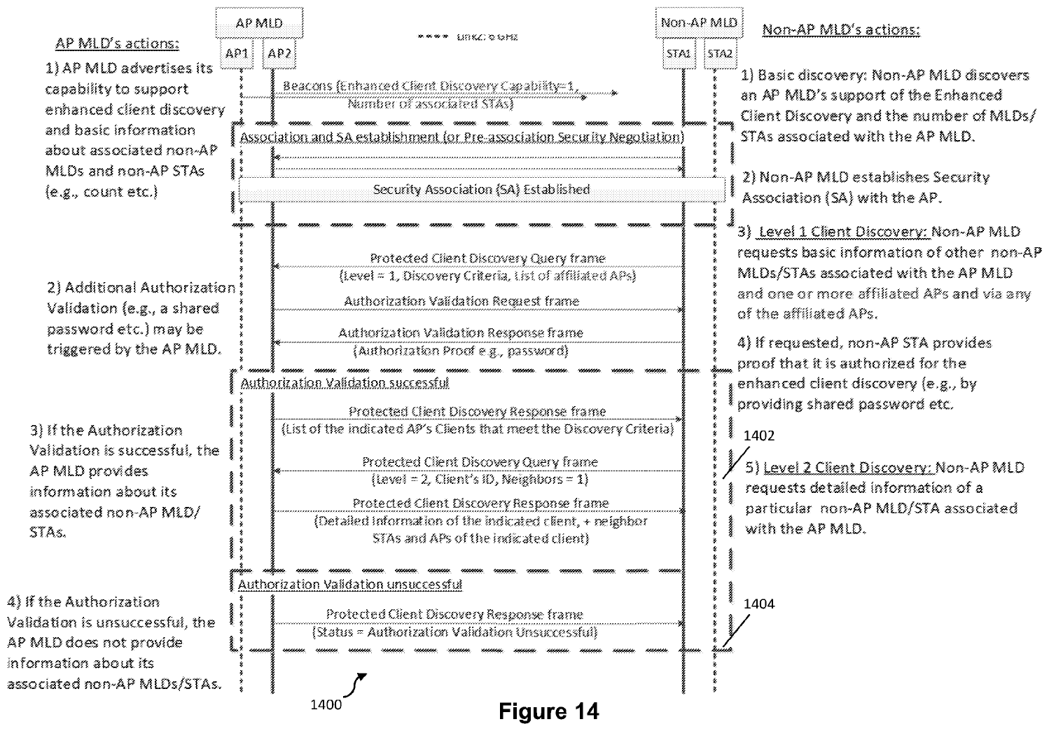

FIG. 14 depicts a flowchart 1400 illustrating an enhanced client discovery procedure between an AP MLD and a non-AP MLD according to the first embodiment of the present disclosure. The AP MLD advertises its capability to support enhanced client discovery and basic information about associated non-AP MLDs and non-AP STAs (e.g., count/number of associated STAs etc.) using a beacon frame. The non-AP MLD may perform a basic discovery and discover an AP MLD's support of the Enhanced Client Discovery and the number of MLDs/STAs associated with the AP MLD. Subsequently, the non-AP MLD may perform association and security association (SA) establishment (or pre-association security negotiation) with the AP MLD.

The non-AP MLD (e.g., via STA1) then transmits a Protected Client Discovery Query frame to request for basic information of other non-AP MLDs/STAs associated with the AP MLD, or any of its affiliated APs, to the AP MLD (e.g., via AP2). The Protected Client Discovery Query frame has its level field set to 1 to indicate a level 1 Enhanced Client Discovery Query and includes Discovery Criteria and a list of affiliated APs (one or more affiliated APs) and via any of the affiliated APs. The AP MLD may perform additional authorization validation to request for verification information or authorization proof (e.g., shared password) that the non-AP MLD is authorized to obtain the basic information of the other non-AP MLDs/STAs by transmitting an Authorization Validation Request frame back to the non-AP MLD. The non-AP MLD then, in response, transmits an Authorization Validation Response frame comprising the verification information or authorization proof (e.g., password) to prove that it is authorized for the enhanced client discovery to obtain the information of the other non-AP MLDs/STAs.

If the Authorization Validation is successful, steps shown in block 1402 are carried out; otherwise step shown in block 1404 is carried out. In particular, if the Authorization Validation is successful, the AP MLD then transmits a Protected Client Discovery Response frame comprising information of a list of AP MLD's clients that meet the Discovery Criteria to the non-AP MLD. Additionally, the non-AP MLD may further transmit a second Protected Client Discovery Query frame to the AP MLD to request for detailed information of a particular non-AP MLD/STA (client) associated with the AP MLD or any of its the affiliated APs. This second Protected Client Discovery Query frame has its level field set to 2 to indicate a level 2 Enhanced Client Discovery Query and indicates a client's ID to identify the non-AP MLD/STA (client) and has its neighbor field set to 1 to indicate information of neighboring devices/clients located within the range of the client.

Although not shown in the figure, upon reception of a Level 2 Client Discovery Query frame, the AP MLD may trigger a neighbor client discovery request to each of its associated non-AP MLDs/STAs to discover information of their neighboring STAs and APs. The AP MLD then transmits a Protected Client Discovery Response frame back to the non-AP MLD comprising detailed information of the indicated client and its neighboring STAs and APs of the indicated client.

If the Authorization Validation is unsuccessful, the AP MLD does not provide information about its associated non-AP MLDs/STAs, but instead will transmit a Protected Client Discovery Response frame with a status field indicating that the Authorization Validation was unsuccessful.

The procedure may also be applicable for the case that a non-AP STA is MLD aware (i.e., it understands MLO related signalling, e.g., Multi-Link elements etc.) and solicits information about its associated non-AP MLDs and non-AP STAs associated with its affiliated APs, from an AP MLD.

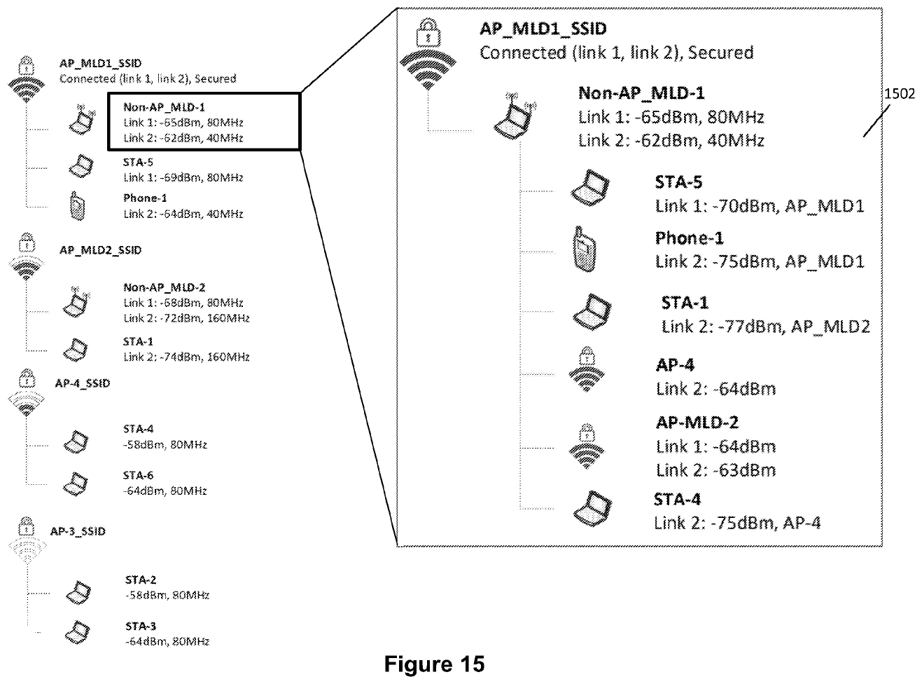

FIG. 15 shows an example visualization of level 1 and level 2 enhanced client discovery results. Such visualization may be displayed on a screen of a laptop, a smartphone or any electronic device. In this example, an SBP initiator (not shown) may perform level 1 client discovery and only a list of APs/AP MLDs (in this case, four different APs (AP MLD1, AP MLD2, AP4, AP3)) may be displayed. Each AP then sends their discovery results comprising a list of STAs (and/or MLDs) associated with the AP with their basic information to the SBP initiator. The results may be sorted in descending order according to their link quality. Optionally, a list of unassociated STAs (and/or MLDs) that the AP is aware of is also provided by the AP. In this example, AP MLD1 provides information of non-AP MLD1, STA5 and Phone1; AP MLD2 provides information of non-AP MLD2 and STA1; AP4 provides information of STA4 and STA6; and AP3 provides information of STA2 and STA3. The SBP initiator may, additionally or alternatively, perform level 2 client discovery. This level 2 client discovery may be trigger upon selecting on a particular STA or non-AP MLD. In this example, the non-AP MLD1 may be selected and the SBP initiator perform level 2 client discovery on non-AP MLD1, a client discovery query frame comprising non-AP MLD1's ID is transmitted to AP MLD1. Accordingly, the AP MLD1 then provides information of non-AP MLD1 as well as its neighboring APs, AP MLDs, STAs, non-AP MLDs (in this case, STA5, Phone1, STA1, AP4, AP MLD2 and STA4) located within the radio range of the affiliated STAs of the non-AP MLD1, as illustrated in block 1502.

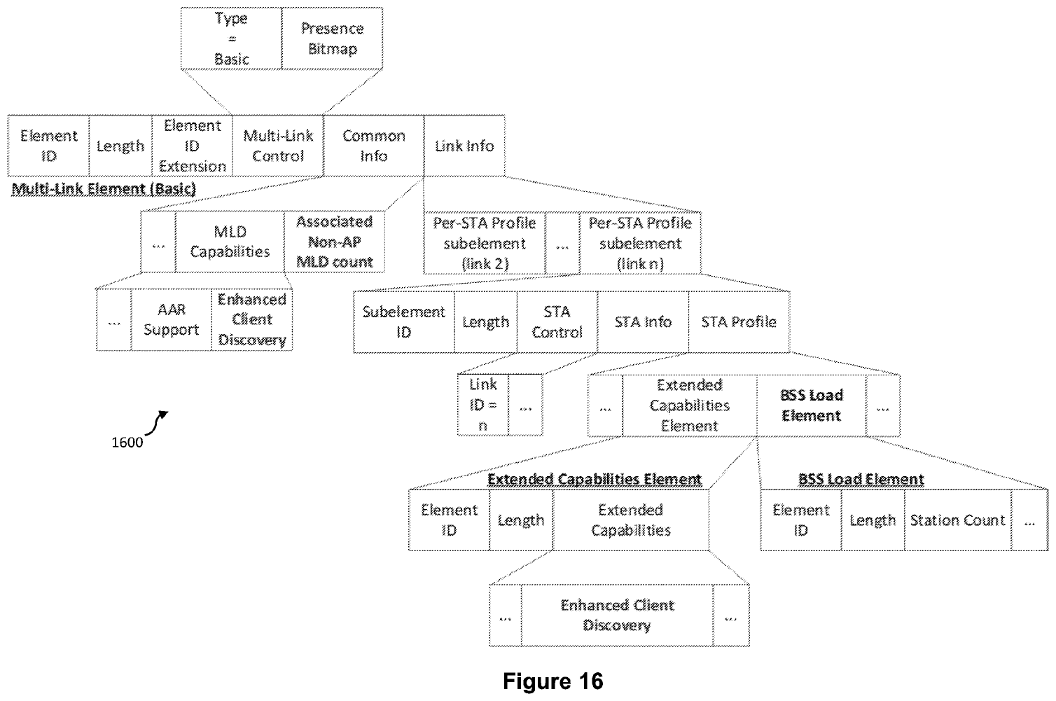

FIG. 16 shows an example format of a multi-link element (MLE) 1600 used for basic discovery according to an embodiment of the present disclosure. The MLE 1600 comprises an Element ID field, a Length field, an Element ID Extension field, a Multi-Link Control field, a Common Info field, a Link Info field. The Multi-Link Control field comprises a Type subfield which is set to “Basic”, and a Presence Bitmap subfield. The Common Info field may comprise an MLD Capabilities subfield and in an AP MLD's case, an Associated non-AP MLD Count subfield. The Associated non-AP MLD Count subfield is used to advertise the total number of non-AP MLD associated with the AP MLD. The MLD Capabilities subfield comprises an AP Assistance Request (AAR) Support subfield and an Enhanced Client Discovery subfield. An AP MLD advertises its support of enhanced client discovery in this Enhanced Client Discovery subfield within the MLD Capabilities subfield.

The Link Info field comprises one or more Per-STA Profile Subelement subfields corresponding to one or more links (corresponding to the affiliated STA/AP), each Per-STA Profile Subelement field comprising an Subelement ID field, a Length field, a STA Control field, a STA Info field and a STA Profile field. The STA Control field comprises a Link ID subfield. The STA Profile field comprises an Extended Capabilities Element subfield and, in an AP MLD's case, a BSS Load Element subfield. The BSS Load Element subfield comprises an Element ID field, a Length field and a Station Count field. The Station Count field is used to advertise the total number of STAs (non-MLD) associated with the affiliated AP operating on the link. The Extended Capabilities Element subfield comprises an Element ID field, a Length field and an Extended Capabilities comprising an Enhanced Client Discovery subfield. A STA or an affiliated STA/AP of an MLD advertises its support of Enhanced Client Discovery in this Enhanced Client Discovery subfield within the Extended Capabilities field of the Extended Capabilities Element subfield.

For an STA/AP that is not an MLD, or an AP affiliated with an AP MLD that is a reporting STA/AP (i.e., STA/AP that is transmitting the frame carrying the Basic Multi-Link element (MLE)), the Extended capabilities Element subfield and the BSS Load Element subfield are carried in the frame body (and not in the Basic MLE). For an affiliated STA/AP of a non-AP MLD or AP MLD, that is not the reporting AP (i.e., the STA/AP is a reported STA/AP), the Extended capabilities Element subfield and the BSS Load Element subfield are carried in Link Info field of the Basic MLE. For AP/AP MLD, the elements are carried in Beacon, Probe Response, (Re) Association Response frames etc. For a non-AP STA/MLD, the element is carried in Probe Request, (Re) Association Request frame etc.

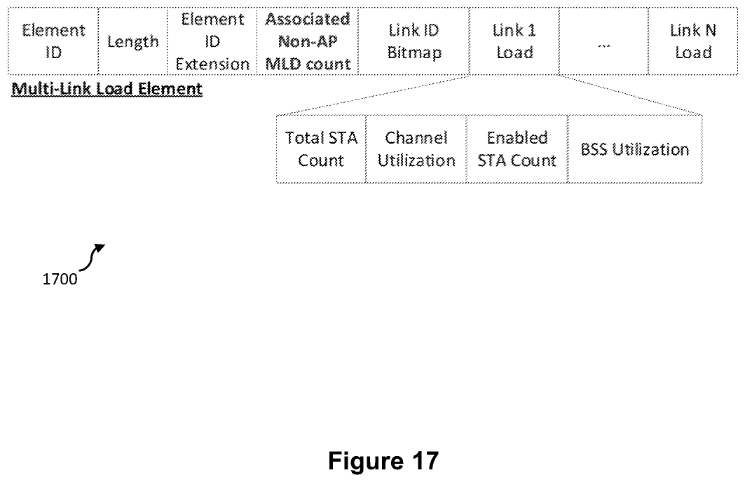

FIG. 17 shows an example format of a Multi-Link Load Element 1700 used by an AP MLD for basic discovery according to an embodiment of the present disclosure. Instead of using an MLE for basic discovery, an AP MLD may use the Multi-Link Load Element 1700 carried in Beacon, Probe Response, (Re) Association Response frame etc. to advertise the number of associated non-AP MLDs as well as the number of non-MLD STAs associated with each of its affiliated APs. The Multi-Link Load Element comprises an Element ID field, a Length field, an Element ID Extension field, an Associated non-AP MLD count field, a Link ID Bitmap field, and one or more Link Load fields. The Associated Non-AP MLD Count field is used to advertise the total number of associated non-AP MLDs. Each Link Load field comprises a Total STA Count subfield, a Channel Utilization subfield, an Enabled STA Count subfield and a BSS Utilization subfield. The Total STA Count subfield is used to advertise the number of STAs (non-MLD) associated with the affiliated AP operating on the link.

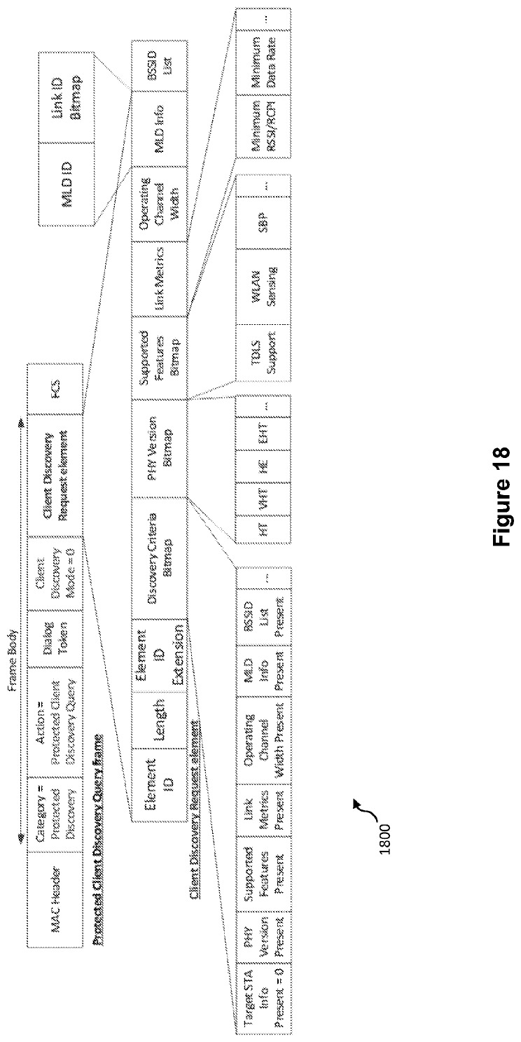

FIG. 18 shows an example format of a Protected Client Discovery Query frame 1800 used for Level 1 Client Discovery Query according to an embodiment of the present disclosure. The Protected Client Discovery Query frame 1800 comprises a MAC Header (Frame Control field, Duration field, Recipient Address (RA) field and Transmitter Address (TA) field), a Category field which is set to “Protected Discovery”, an Action field which is set to “Protected Client Discovery Query”, a Dialog Token field, a Client Discovery Mode field, a Client Discovery Request Element field and a frame checking sequence (FCS) field. The Client Discovery may be set to 0, 1 or 2 to indicate a Level 1, 2 or 3 Client Discovery respectively. In this case, as the Protected Client Discovery Query frame 1800 is used for Level 1 Client Discovery Query, the Client Discovery Mode field is set to 0.

The Client Discovery Request element field comprises an Element ID field, a Length field, an Element ID Extension field, a Discovery Criteria Bitmap field, a PHY Version Bitmap field, a Supported Features Bitmap field, a Link Metrics field, an Operating Channel Width field, an MLD Info field and a BSSID List field. The Discovery Criteria Bitmap field comprises a Target STA Info Present subfield, a PHY Version Present subfield, a Supported Features Present subfield, a Link Metrics Present subfield, an Operating Channel Width Present subfield, an MLD Info Present subfield and a BSSID List Present subfield, indicating the presence of the appending fields used as criteria for selecting STAs/non-AP MLDS. The Target STA Info Present subfield is set to 0 in level 1 Client Discovery. The PHY Version Bitmap field comprises a High Throughput (HT) subfield, a Very High Throughput (VHT) subfield, a High Efficiency (HE) subfield and an Extremely High Throughput (EHT) subfield to indicate the PHY Version(s) supported by the STAs/non-AP MLDs. The Supported Features Bitmap indicates the features to be supported by the target non-AP STAs and comprises a Tunneled Direct Link Setup (TDLS) Support subfield, a WLAN Sensing subfield and an SBP subfield etc. to indicate the features supported by the STAs/non-AP MLD. The Link Metric field comprises a Minimum RSSI/RCPI subfield and a Minimum Data Rate subfield to indicate the link metrics supported by the STAs/non-AP MLDs. The link metrics are measured between the STA and the associated AP. The Operating Channel Width field indicates the operating channel width of the STA to be discovered. The MLD Info field is present only if the frame is addressed to an AP affiliated with an AP MLD and comprises an MLD ID subfield carrying the MLD ID of the AP MLD as well as a Link ID Bitmap subfield carrying the links for which information is requested.

If the BSSID List field is present, information about the non-AP STAs associated with all the BSSIDs are solicited. If the BSSID List field is not present, by default, a non-MLD AP will only provide information about its own associated non-AP STAs, while an AP MLD will provide information about non-AP STAs associated with all its affiliated APs (in addition to information about associated non-AP MLDs).

Additionally, the Discovery Criteria Bitmap field may also comprise a “Device Location” bit (not shown), which, when set, indicates that a Device Location element (as defined in IEEE 802.11-2020) and a coverage area information (e.g. signal strength radius) is included in the Client Discovery Query frame and indicates the target geographic location that the non-AP STAs or non-AP MLDs are expected to be located in (e.g., within-62 dBm RSSI/RCPI radius). The Discovery Criteria Bitmap field may also comprise a “include associated STAs only” bit (not shown) to indicate that information about non-AP STAs/MLDs that are not associated with the AP/AP MLD is not solicited when the bit is set to 1, or the AP/AP MLD may include information about non-AP STAs/MLDs that are not associated with the AP/AP MLD in the Client Discovery Response when the bit is set to 0.

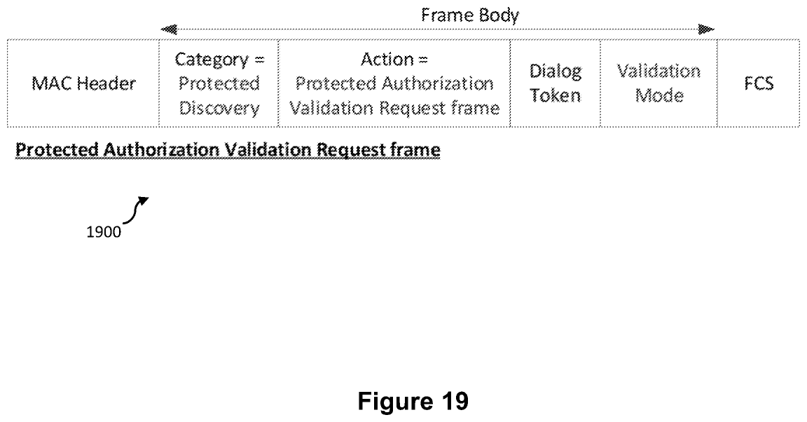

FIG. 19 shows an example format of a Protected Authorization Validation Request frame 1900 according to an embodiment of the present disclosure. The Protected Authorization Validation Request frame 1900 comprises a MAC Header (Frame Control field, Duration field, RA field and TA field), a Category field which is set to “Protected Discovery”, an Action field which is set to “Protected Authorization Validation Request frame”, a Dialog Token field, a Validation Mode field and a FCS field. The Validation Mode field may be set to 0 to indicate a plain text password and 1 to indicate a hashed password.

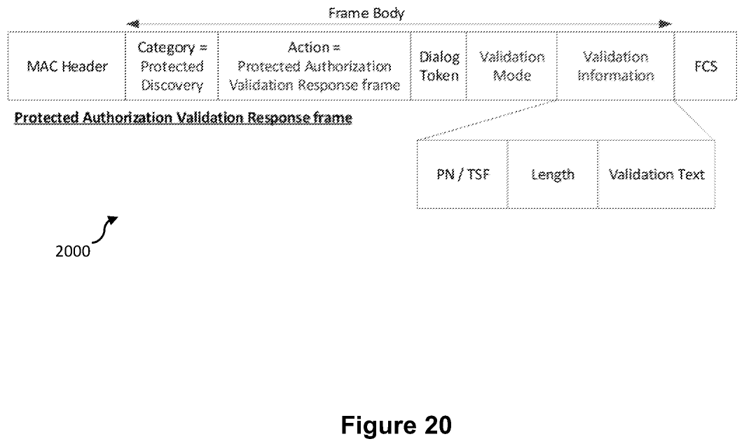

FIG. 20 shows an example format of a Protected Authorization Validation Response frame 2000 according to an embodiment of the present disclosure. The Protected Authorization Validation Response frame 2000 comprises a MAC Header (Frame Control field, Duration field, RA field and TA field), a Category field which is set to “Protected Discovery”, an Action field which is set to “Protected Authorization Validation Response frame”, a Dialog Token field, a Validation Mode field, a Validation Information field and a FCS field. The Validation Information field comprises a PN/TSF field, a Length field and a Validation Text field. The PN/TSF field carries the Packet Number or the Time Synchronization Function that is used as salt to prevent replay attacks. The Length field indicates a length of the Validation Text carried in the Validation Text field and the Validation Text field carries the plain text password or hashed password based on the Validation Mode field.

As mentioned earlier, Authorization Validation Request/Response may be skipped if the AP has other means to verify the non-AP STA's authorization to obtain information about other non-AP STAs; for example, the AP may maintain a list of authorized devices, or it may consult with a list of authorized devices from a database on a server etc.

For example, a Hashed password is SHA-256 (Key, PN/TSF∥“Plain text password), where Key is a common private secret key known to both parties, e.g., a PTK generated during the Security Association, or it may be a separate application specific secret key (e.g., passed by upper layer application) for the sole purpose of usage with Enhanced Client Discovery, “∥” is a concatenation action, and PN/TSF is the value of the PN/TSF field, and the transmitter should ensure that the same value is never used twice to prevent replay attacks. For e.g., it may be a monotonously increasing number, or may contain the current value of the transmitter's Time Synchronization Function (TSF).

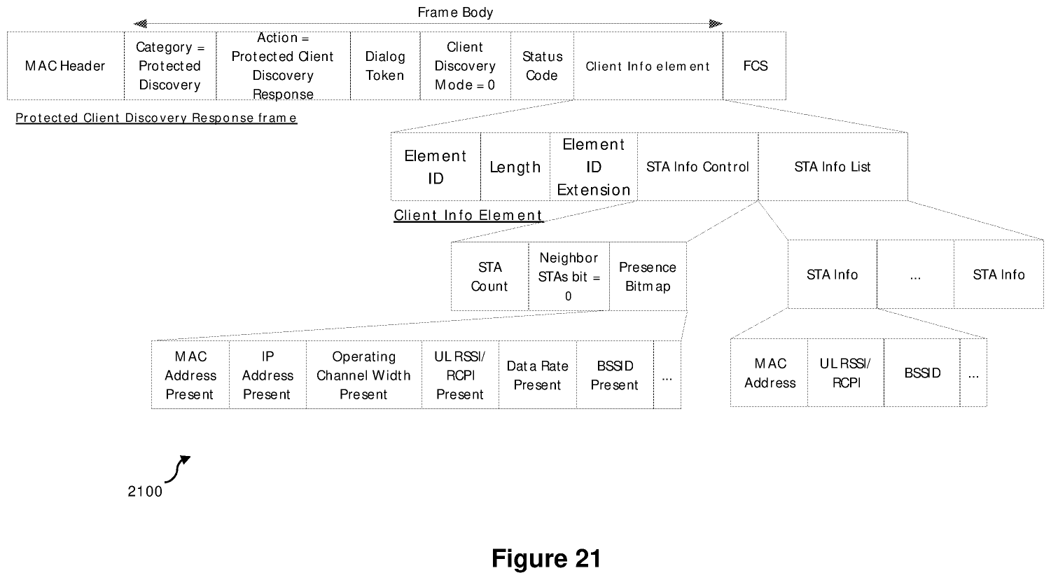

FIG. 21 shows an example format of a level 1 Client Discovery Response frame 2100 according to an embodiment of the present disclosure. The Client Discovery Response frame 2100 is transmitted between non-MLD SBP initiator and responder. The Client Discovery Response frame 2100 comprises a MAC Header (Frame Control field, Duration field, RA field and TA field), a Category field which is set to “Protected Discovery”, an Action field which is set to “Protected Client Discovery Response”, a Dialog Token field, a Client Discovery Mode field which is set to 0 to indicate a Level 1 Client Discovery, a Status Code field, a Client Info Element field and a FCS field. The Client Info Element field comprises an Element ID field, a Length field, an Element ID Extension field, a STA Info Control field and a STA Info List field. The STA Info Control field comprises a STA count subfield, a Neighbor STAs bit and a Present Bitmap subfield. The STA Count subfield indicates the number of STA Info fields present in the STA Info List field (1 per non-AP STA). The Neighbor STAs bit is set to 0 to indicate that the STA Info List carries information of associated STAs (and optionally unassociated non-AP STAs within range of the AP). The Present Bitmap subfield indicates the fields that are present I the STA Info field(s) and comprises a MAC Address Present subfield, an Internet Protocol (IP) Address Present subfield, an Operating Channel Width Present subfield, a UL RSSI/RCPI Present subfield, a Data Rate Present subfield and a BSSID Present subfield. The STA Info List field comprises one or more STA Info fields. Each STA Info field carries information of each associated non-AP STA that meet the discovery criteria indicated in the Client Discovery Query frame and comprises a MAC Address subfield carrying the non-AP STA's MAC address, an Internet Protocol (IP) Address subfield, an Operating Channel Width subfield, a UL RSSI/RCPI subfield and BSSID subfield carrying the BSSID of the associated AP.

Additionally, the STA Info field may also comprise capabilities and operation parameters (not shown) of the STA (e.g., Basic, HT, VHT, HE, EHT, WLAN Sensing capabilities elements, HT, VHT, HE, EHT Operation elements etc.). The STA Info may also comprise a Device Type field (e.g., Laptop, PC, Smartphone, Smart Appliance etc.) and a Device Location element field (as defined in IEEE 802.11-2020) that indicates the geographic location that the non-AP STAs or non-AP MLDs is located (e.g., within 10 ms radius). When the STA Info carries information of DMG (directional multi-gigabit i.e., 802.11ad) or EDMG (enhanced directional multi-gigabit i.e., 802.11ay) STAs, the STA Info field may also carry a Sector Select subfield (not shown) that contains the value of the Sector ID subfield of the SSW field within the frame that was received with best quality in the immediately preceding sector sweep. The Sector ID subfield is set to indicate the sector number through which the frame containing this SSW field is transmitted.

If the Discovery Criteria Bitmap in the query frame also includes a “include associated STAs only” bit, the information about non-AP STAs that are not associated with the AP in the Client Discovery Response frame is not included when the bit is set to 1, and the AP may include information about non-AP STAs that are not associated with the AP in the Client Discovery Response frame when the bit is set to 0. It is noted that the AP may maintain a list of unassociated non-AP STAs that have previously performed any frame exchanges with it (e.g., probe request/responses), or attempted association with the AP, or was disassociated from the AP within a certain time window (e.g., 30 mins etc.).

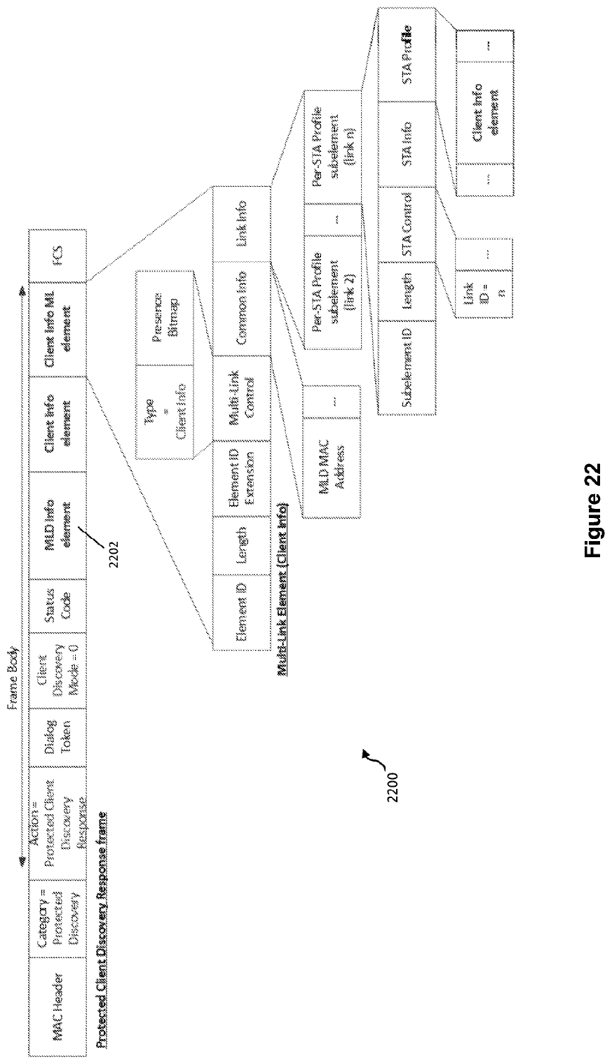

FIG. 22 shows another example format of a level 1 Client Discovery Response frame 2200 according to an embodiment of the present disclosure. The Client Discovery Response frame 2200 is transmitted between MLD SBP initiator (e.g., non-AP MLD) and an AP MLD. The Client Discovery Response frame 2200 comprises a MAC Header (Frame Control field, Duration field, RA field and TA field), a Category field which is set to “Protected Discovery”, an Action field which is set to “Protected Client Discovery Response”, a Dialog Token field, a Client Discovery Mode field which is set to 0 to indicate a Level 1 Client Discovery, a Status Code field, an MLD Info Element field 2202, a Client Info Element field, a Client Info ML Element field and a FCS field. The MLD Info Element field 2202 carries information of the associated non-AP MLDs whose at least one affiliated STA meet the Discovery criteria. The Client Info Element field carries information of non-AP STAs provided by the affiliated AP transmitting the response frame 2200. The Client Info ML Element field is a new “Client Info” variant of ML element which carries information of non-AP STAs provided by affiliated APs other than the one transmitting the response frame 2200.

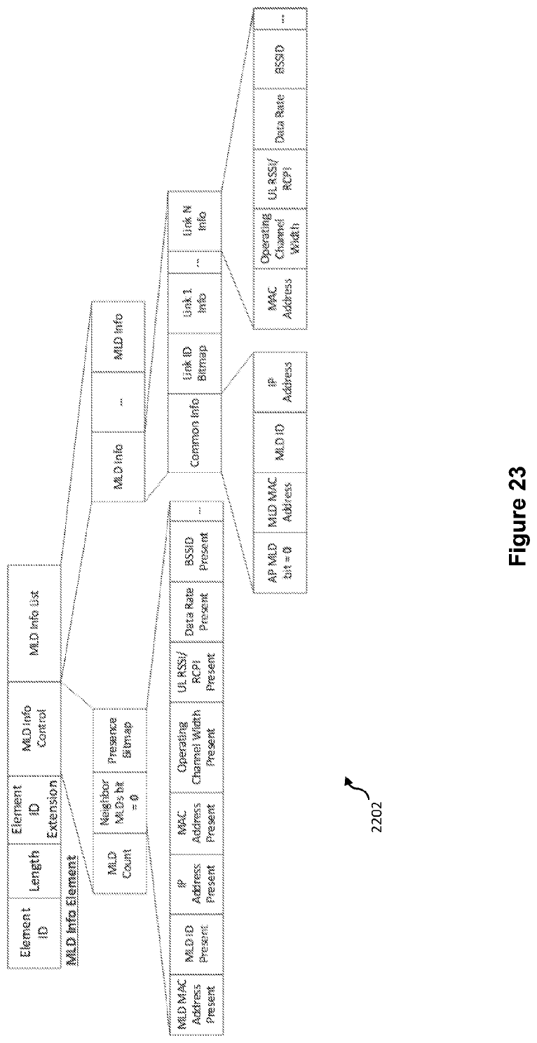

FIG. 23 shows an example format of the MLD Info Element field 2202 of the Protected Client Discovery Response frame 2200 depicted in FIG. 22. The MLD Info Element field 2202 comprises an Element ID field, a Length field, an Element ID Extension field, an MLD Info Control field and an MLD Info List field. The MLD Info Control field comprises an MLD count subfield, a Neighbor MLDs bit and a Present Bitmap subfield. The MLD Count subfield indicates the number of MLD Info fields present in the STA Info List field (1 per non-AP MLD). The Neighbor MLDs bit is set to 0 to indicate that the MLD Info List carries information of associated MLDs (as opposed to neighboring MLDs). The Present Bitmap subfield comprises an MLD MAC Address Present subfield, an MLD ID Present subfield, an IP Address Present subfield, a MAC Address Present subfield, an Operating Channel Width Present subfield, a UL RSSI/RCPI Present subfield, a Data Rate Present subfield and a BSSID Present subfield. The MLD MAC Address Present subfield, the MLD ID Present subfield and the IP Address Present subfield indicate the presence of corresponding fields in the Common Info subfield of each MLD Info field, while the MAC Address Present subfield, the Operating Channel Width Present subfield, the UL RSSI/RCPI Present subfield, the Data Rate Present subfield and the BSSID Present subfield indicate the presence of corresponding fields in the Link Info subfield of each MLD Info field.

The MLD Info List field comprises one or more MLD Info fields. Each MLD Info field carries information of a non-AP MLD whose at least one affiliated STA meets the discovery criteria indicated in the Client Discovery Query frame and comprises a Common Info subfield, a Link ID Bitmap subfield and one or more Link Info subfields. The Common Info subfield comprises an AP MLD bit, an MLD MAC Address subfield an MLD ID subfield and an IP Address subfield. The AP MLD bit indicates the type of the MLD. The AP MLD bit may be set to 0 to indicate a non-AP MLD and 1 to indicate an AP MLD. In this case, the AP MLD bit is set to 0 indicating a non-AP MLD. The MLD MAC Address subfield carries the non-AP MLD's MAC Address. The MLD ID carries the MLD ID of the associated AP MLD.

The Link ID Bitmap subfield indicates the links of the MLD whose information is carried in the Link Info subfields. Each Link Info subfield carries information of each non-AP STA provided by the affiliated AP operating on that link and that meet the discovery criteria indicated in the Client Discovery Query frame, and comprises a MAC Address subfield carrying the affiliated non-AP STA's MAC address, an Operating Channel Width subfield, UL RSSI/RCPI subfield, a Data Rate subfield and a BSSID subfield carrying the BSSID of the associated AP.

The Link Info subfield of the MLD Info field may also comprise capabilities and operation parameters (not shown) of the STA (e.g., Basic, HT, VHT, HE, EHT, WLAN Sensing capabilities elements, HT, VHT, HE, EHT Operation elements etc.). The Common Info subfield of the MLD Info may also comprise the MLD capabilities element, a Device Type (e.g., Laptop, PC, Smartphone, Smart Appliance etc.) and a Device Location element (as defined in IEEE 802.11-2020) that indicates the geographic location that the non-AP STAs or non-AP MLDs is located (e.g., within-62 dBm RSSI/RCIP radius) etc.

Additionally, if the Discovery Criteria Bitmap in the query also includes a “include associated STAs only” bit, the information about non-AP STAs/MLDs that are not associated with the affiliated APs/AP MLD is not included in the Client Discovery Response when the bit is set to 1; but the AP MLD may include the information about non-AP STAs/MLDs that are not associated with the affiliated APs/AP MLD in the Client Discovery Response when the bit is set to 0. It is noted that the AP MLD may maintain a list of unassociated non-AP STAs and/or non-AP MLDs that have previously performed any frame exchanges with it (e.g., probe request/responses), or attempted association with the AP MLD or affiliated APs, or was disassociated from the AP MLD or any affiliated APs within a certain time window (e.g., 30 mins etc.).

Returning to FIG. 22, the Client Info ML Element field comprises an Element ID field, a Length field, an Element ID Extension field, a Multi-Link Control field, a Common Info field and a Link Info field. The Multi-Link Control field comprises a Type subfield which is set to “Client Info”, and a Presence Bitmap subfield.

Table 1 shows various Multi-Link element variants corresponding to the values of the Type subfield.

| Type subfield value | Multi-Link element variant name |
|---|---|
| 0 | Basic |
| 1 | Probe Request |
| 2 | Reconfiguration |
| 3 | TDLS |
| 4 | Priority Access |
| 5 | Sensing |
| 6 | Client Info |

The Common Info field comprises an MLD MAC Address subfield carrying the AP MLD's MLD MAC Address. The Link Info field comprises one or more Per-STA Profile Subelement subfields corresponding to one or more links, each Per-STA Profile Subelement field comprising an Subelement ID field, a Length field, a STA Control field, a STA Info field and a STA Profile field. The STA Control field comprises a Link ID subfield corresponding to the affiliated AP operating on that link. The STA Profile field carries information of non-AP STAs associated with the affiliated AP operating on the link.

Additionally, the STA Info field may also comprise the affiliated AP's supported capabilities, PHY versions Channel width as well as location (e.g., Basic, HT, VHT, HE, EHT, WLAN Sensing capabilities elements, HT, VHT, HE, EHT Operation elements etc.). The location information may be obtained via GPS (when outdoors), or via Fine Time Measurements and/or Ranging (when indoors) etc. When the STA Info field in a Client Discovery Response frame carries information of DMG (directional multi-gigabit i.e., 802.11ad) or EDMG (enhanced directional multi-gigabit i.e., 802.11ay) STAs, the STA Info field may also carry a Sector Select subfield that contains the value of the Sector ID subfield of the SSW field within the frame that was received with best quality in the immediately preceding sector sweep. The Sector ID subfield indicates the sector number through which the frame containing this SSW field is transmitted. When choosing a Sensing Responder STA among DMG/EDMG STAs, the AP may consider the information of the sector number. The STA Profile field carries a Client Info element carrying information of non-AP STAs associated with the affiliated AP operating on the link.

If the Discovery Criteria Bitmap in the query frame also includes a “include associated STAs only” bit, the AP may not include information about non-AP STAs that are not associated with the AP in the Client Discovery Response frame when the bit is set to 1 and, the AP may include information about non-AP STAs that are not associated with the AP in the Client Discovery Response frame when the bit is set to 0. It is noted that the AP may maintain a list of unassociated non-AP STAs that have previously performed any frame exchanges with it (e.g., probe request/responses), or attempted association with the AP, or was disassociated from the AP within a certain time window (e.g., 30 mins etc.).

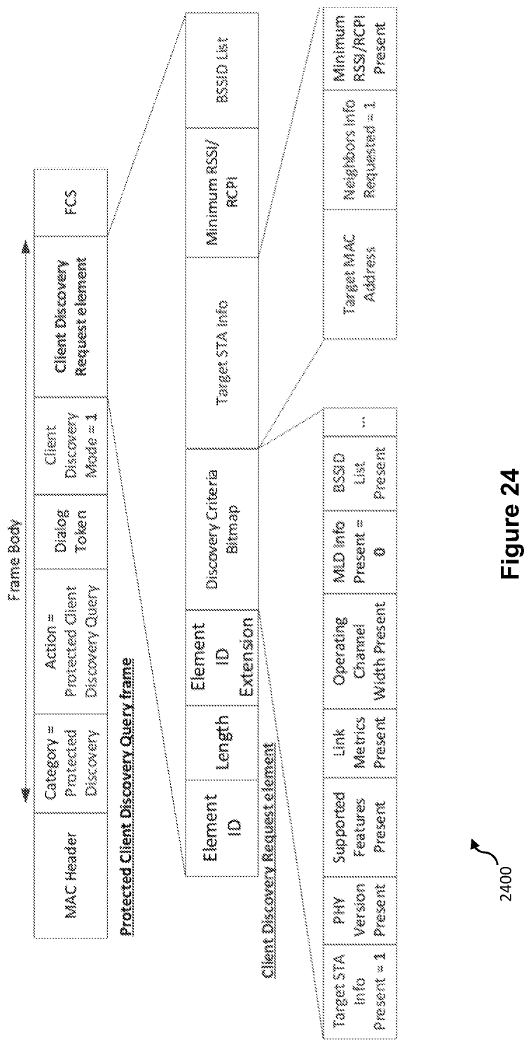

FIG. 24 shows an example format of a Protected Client Discovery Query frame 2400 used for Level 2 Client Discovery Query according to an embodiment of the present disclosure. The Protected Client Discovery Query frame 2400 comprises a MAC Header (Frame Control field, Duration field, RA field and TA) field, a Category field which is set to “Protected Discovery”, an Action field which is set to “Protected Client Discovery Query”, a Dialog Token field, a Client Discovery Mode field, a Client Discovery Request Element field and a FCS field. The Client Discovery is set to 1 is to indicate a Level 2 Client Discovery Query.

The Client Discovery Request Element field comprises an Element ID field, a Length field, an Element ID Extension field, a Discovery Criteria Bitmap field, a Target STA Info field a Minimum RSSI/RCPI field and a BSSID field.

PHY Version Bitmap field, a Supported Features Bitmap field, a Link Metrics field, an Operating Channel Width field, an MLD Info field and a BSSID List field. The Discovery Criteria Bitmap field comprises a Target STA Info Present subfield, a PHY Version Present subfield, a Supported Features Present subfield, a Link Metrics Present subfield, an Operating Channel Width Present subfield, an MLD Info Present subfield and a BSSID List Present subfield. The subfields are set to 1 to indicate the presence of the appending fields used as criteria for selecting non-AP STA or affiliated STAs of the requested non-AP MLD. The Target STA Info Present subfield is set to 1 in level 2 Client Discovery.

The PHY Version Bitmap field comprises a HT subfield, a VHT subfield, a HE subfield and an EHT subfield to indicate the PHY Version(s) supported by the STAs/non-AP MLDs. The Supported Features Bitmap indicates the features to be supported by the target non-AP STAs and comprises a Tunneled Direct Link Setup (TDLS) Support subfield, a WLAN Sensing subfield and an SBP subfield to indicate the features supported by the STAs/non-AP MLD. The Link Metric field comprises a Minimum RSSI/RCPI subfield and a Minimum Data Rate subfield to indicate the link metrics supported by the STAs/non-AP MLDs. The link metrics are measured between the STA and the associated AP. The Operating Channel Width field indicates the operating channel width of the STA to be discovered. The MLD Info field is present only if the frame is addressed to an AP affiliated with an AP MLD and comprises an MLD ID subfield carrying the MLD ID of the AP MLD as well as a Link ID Bitmap subfield carrying the links for which information is requested.

If the BSSID List field is present, information about the non-AP STAs associated with all the BSSIDs are solicited. If the BSSID List field is not present, by default, a non-MLD AP will only provide information about its own associated non-AP STAs, while an AP MLD will provide information about non-AP STAs associated with all its affiliated APs (in addition to information about associated non-AP MLDs).

The Target STA Info field carries information of the requested/indicated non-AP STA or non-AP MLD (i.e., STA or MLD of interest), and comprises a Target MAC Address subfield, a Neighbors Info Requested subfield and a Minimum RSSI/RCPI Present subfield. The Target MAC Address subfield carries MAC address of the requested non-AP STA, or the MLD MAC Address of the requested non-AP MLD. Alternatively, AID or UID may be provided instead of MAC address. The Neighbors Info Requested subfield is set to 1 if information about neighboring devices is also requested.

The Minimum RSSI/RCPI field indicates the link metrics supported by link with the neighboring devices. The link metrics are measured between the Target STA and its neighboring STAs located within a radio range of the Target STA. The BSSID List, if present, the neighboring STAs are limited to the ones associated with the APs corresponding to the BSSIDs in the List.

Additionally, the Discovery Criteria Bitmap may also comprise a “exclude APs” bit to indicate that information about APs/AP MLDs is not solicited when the bit is set to 1 or the non-AP STA/non-AP MLD may include information about APs/AP-MLDs as well in the Client Discovery Response when the bit is set to 0.

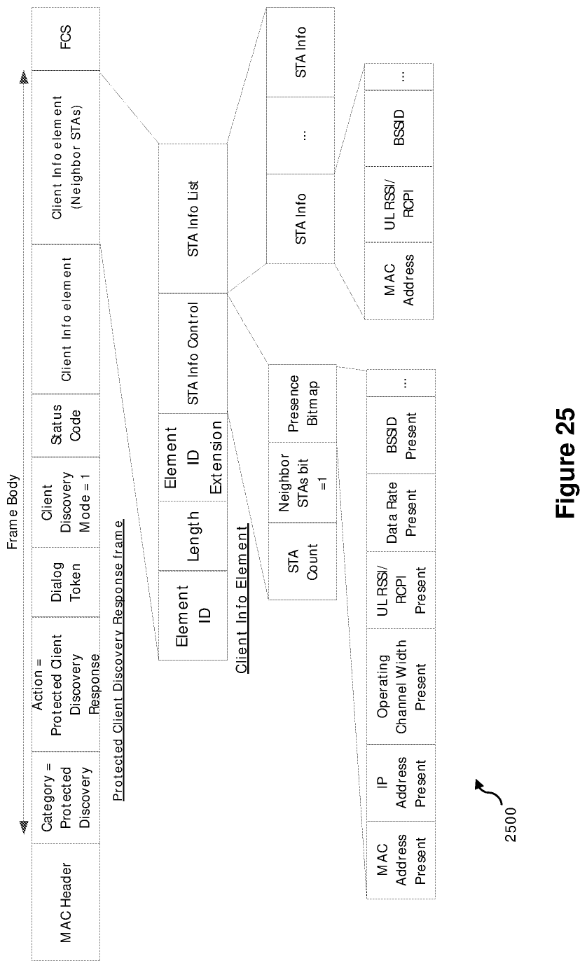

FIG. 25 shows an example format of a level 2 Client Discovery Response frame 2500 according to an embodiment of the present disclosure. The Client Discovery Response frame 2500 is transmitted between non-MLD SBP initiator and SBP responder. The Client Discovery Response frame 2500 comprises a MAC Header (Frame Control field, Duration field, RA field and TA field), a Category field which is set to “Protected Discovery”, an Action field which is set to “Protected Client Discovery Response”, a Dialog Token field, a Client Discovery Mode field which is set to 1 to indicate a Level 2 Client Discovery, a Status Code field, a Client Info Element field and a FCS field. The Client Info Element field comprises an Element ID field, a Length field, an Element ID Extension field, a STA Info Control field and a STA Info List field. The STA Info Control field comprises a STA count subfield, a Neighbor STAs bit and a Present Bitmap subfield. The STA Count subfield indicates the number of STA Info fields present in the STA Info List field (1 per neighboring non-AP STA). The Neighbor STAs bit is set to 1 to indicate that the STA Info List carries information of neighboring STAs. The Present Bitmap subfield comprises a MAC Address Present subfield (set to 0), an Internet Protocol (IP) Address Present subfield (set to 0), an Operating Channel Width Present subfield (set to 0), a UL RSSI/RCPI Present subfield, a Data Rate Present subfield (set to 0) and a BSSID Present subfield.

The STA Info List field comprises one or more STA Info fields. Each STA Info field carries information of each neighboring non-AP STA that meet the discovery criteria indicated in the Client Discovery Query frame and comprises a MAC Address subfield carrying the neighboring non-AP STA's MAC address, a UL RSSI/RCPI subfield and BSSID subfield carrying the BSSID of the BSS with which the neighboring non-AP STA is associated or the BSSID of the AP itself. If the MAC Address field and the BSSID fields are the same, it indicates that this is an AP. The UL RSSI/RCPI field indicates the RSSI/RCPI observed on the direct link between the non-AP STA and its neighboring non-AP STA, or the RSSI/RCPI observed on the link between the non-AP STA and its neighboring AP.

Additionally, the STA Info field may comprise the STA's supported capabilities, PHY versions, Channel width as well as location of the STAs. The location information may be obtained via GPS (when outdoors), or via Fine Time Measurements and/or Ranging (when indoors) etc. When the STA Info field in a Client Discovery Response frame carries information of DMG (directional multi-gigabit i.e., 802.11ad) or EDMG (enhanced directional multi-gigabit i.e., 802.11ay) STAs, the STA Info field may also carry a Sector Select subfield that contains the value of the Sector ID subfield of the SSW field within the frame that was received with best quality in the immediately preceding sector sweep. The Sector ID subfield indicates the sector number through which the frame containing this SSW field is transmitted. When choosing a Sensing Responder STA among DMG/EDMG STAs, the AP may use the consider the information of the sector number.

When the Discovery Criteria Bitmap in the query includes the “exclude APs” bit, the information about APs is not included in the Client Discovery Response when the bit is set to 1, and the non-AP STA/non-AP MLD may include information about APs as well in the Client Discovery Response when the bit is set to 0.

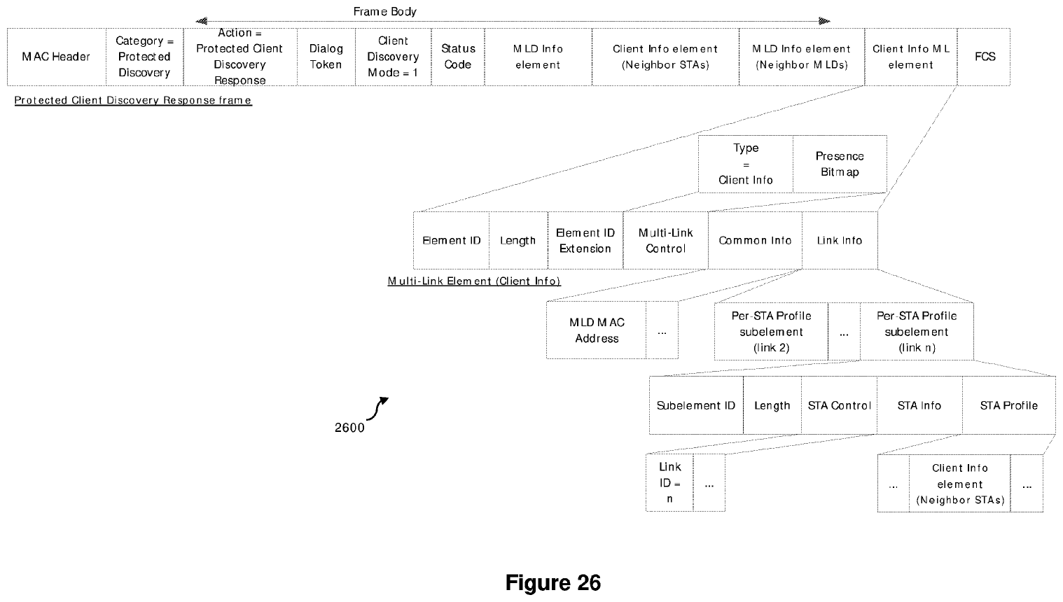

FIG. 26 shows another example format of a level 2 Client Discovery Response frame 2600 according to an embodiment of the present disclosure. The Client Discovery Response frame 2600 is transmitted between MLD SBP initiator (e.g., non-AP MLD) and responder (AP MLD). The Client Discovery Response frame 2600 comprises a MAC Header (Frame Control field, Duration field, RA field and TA field), a Category field which is set to “Protected Discovery”, an Action field which is set to “Protected Client Discovery Response”, a Dialog Token field, a Client Discovery Mode field which is set to 1 to indicate a Level 2 Client Discovery, a Status Code field, an MLD Info Element field, a Client Info Element (Neighbor STAs) field, an MLD Info Element (Neighbor MLDs) field, a Client Info ML Element field and a FCS field. The MLD Info Element field carries information of the requested non-AP MLDs (i.e., if the Neighbor MLDs bit is set to 0, the response frame 2600 carries only a single MLD Info Element field without any MLD Info Element (Neighbor MLDs) field. The Client Info Element (Neighbor STAs) field carries information of neighboring STAs and APs of the affiliated STA transmitting the response frame 2600 and that meet the link metric criteria indicated in the Client Discovery Query frame. The MLD Info Element (Neighbor MLDs) field carries information of neighboring MLDs (i.e., when Neighboring MLDs bit is set to 1).

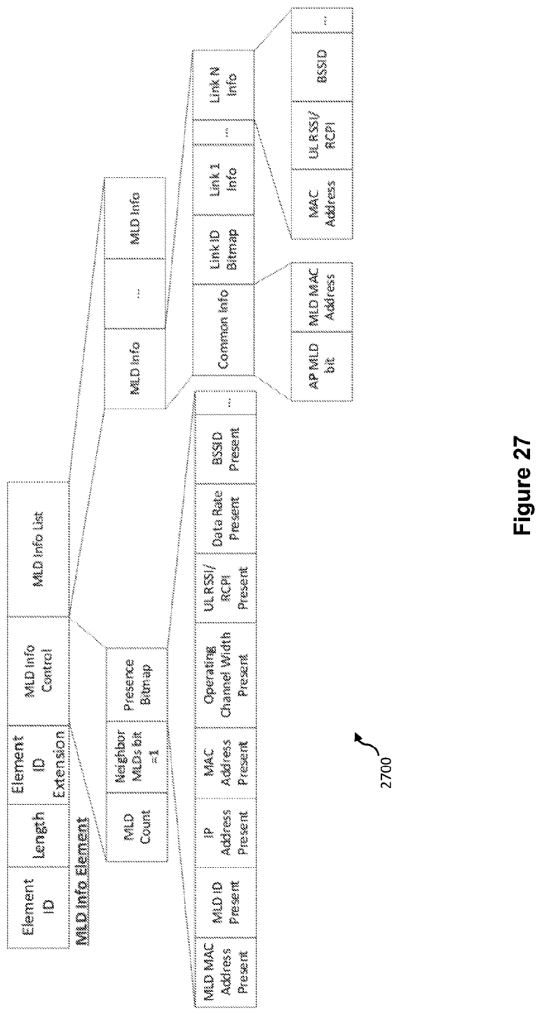

FIG. 27 shows an example format of the MLD Info Element field of the Protected Client Discovery Response frame 2600 depicted in FIG. 26. The MLD Info Element field comprises an Element ID field, a Length field, an Element ID Extension field, an MLD Info Control field and an MLD Info List field. The MLD Info Control field comprises an MLD count subfield, a Neighbor MLDs bit and a Present Bitmap subfield. The MLD Count subfield indicates the number of MLD Info fields present in the STA Info List field (1 per non-AP MLD). The Neighbor MLDs bit is set to 1 to indicate that the MLD Info List carries information of neighboring MLDs. The Present Bitmap subfield comprises an MLD MAC Address Present subfield, an MLD ID Present subfield, an IP Address Present subfield, a MAC Address Present subfield, an Operating Channel Width Present subfield, a UL RSSI/RCPI Present subfield, a Data Rate Present subfield and a BSSID Present subfield. The MLD MAC Address Present subfield, the MLD ID Present subfield and the IP Address Present subfield indicate the presence of corresponding fields in the Common Info subfield of each MLD Info field. All bits except MLD MAC Address Present bit are set to 0. The MAC Address Present subfield, the Operating Channel Width Present subfield, the UL RSSI/RCPI Present subfield, the Data Rate Present subfield and the BSSID Present subfield indicate the presence of corresponding fields in the Link Info subfield of each MLD Info field. All bits except UL RSSI/RCPI Present bit are set to 0.

The MLD Info List field comprises one or more MLD Info fields. Each MLD Info field carries information of a neighboring MLD whose at least one affiliated STA meets the discovery criteria indicated in the Client Discovery Query frame and comprises a Common Info subfield, a Link ID Bitmap subfield and one or more Link Info subfields. The Common Info subfield comprises an AP MLD bit, an MLD MAC Address subfield, an MLD ID subfield and an IP Address subfield. The AP MLD bit indicates the type of the MLD. The AP MLD bit may be set to 0 to indicate a non-AP MLD and 1 to indicate an AP MLD. The MLD MAC Address subfield carries the MLD's MAC Address.

The Link ID Bitmap subfield indicates the links whose information is carried in the Link Info subfields. Each Link Info subfield carries information of the STA affiliated with the neighboring MLD and comprises a MAC Address subfield carrying the affiliated STA's MAC address, a UL RSSI/RCPI subfield and a BSSID subfield carrying the BSSID of the associated AP of the affiliated non-AP STA for non-AP MLD. The BSSID subfield is not present for AP MLD.

Additionally, the Link Info subfield may also comprise capabilities and operation parameters of the STA (e.g., Basic, HT, VHT, HE, EHT, WLAN Sensing capabilities elements, HT, VHT, HE, EHT Operation elements etc.). When the Link Info subfield carries information of DMG (directional multi-gigabit i.e., 802.11ad) or EDMG (enhanced directional multi-gigabit i.e., 802.11ay) STAs, the STA Info field may also carry a Sector Select subfield that contains the value of the Sector ID subfield of the SSW field within the frame that was received with best quality in the immediately preceding sector sweep. The Sector ID subfield is set to indicate the sector number through which the frame containing this SSW field is transmitted.

The Common Info subfield of the MLD Info field may also comprise the MLD capabilities element and a Device Location element (as defined in IEEE 802.11-2020) is included in the Client Discovery Request element and indicates the geographic location that the MLD is located (e.g., within 10 ms radius or within-62 dBm RSSI/RCPI radius) etc.

Returning to FIG. 26, the Client Info ML Element carries information of neighbor STAs and APs of the affiliated non-AP STAs other than the one transmitting the Response frame and comprises an Element ID field, a Length field, an Element ID Extension field, a Multi-Link Control field, a Common Info field and a Link Info field. The Multi-Link Control field comprises a Type subfield which is set to “Client Info”, for example according to Table 1, and a Presence Bitmap subfield.

The Common Info field comprises an MLD MAC Address subfield carrying the requested non-AP MLD's MLD MAC Address. The Link Info field comprises one or more Per-STA Profile Subelement subfields corresponding to one or more links, each Per-STA Profile Subelement field comprising an Subelement ID field, a Length field, a STA Control field, a STA Info field and a STA Profile field. The STA Control field comprises a Link ID subfield. The STA Profile field carries the Client Info element with its Neighbor STAs bit set to 1 and carrying information of the neighboring non-AP STAs and APs of the affiliated non-AP STA operating on the link.

Additionally, the Discovery Criteria Bitmap may also comprise a “exclude APs” bit to indicate that information about APs/AP MLDs is not included in the Client's Discovery Response frame 2600 when the bit is set to 1, and the non-AP STA/non-AP MLD may include information about APs/AP-MLDs as well in the Client Discovery Response when the bit is set to 0.

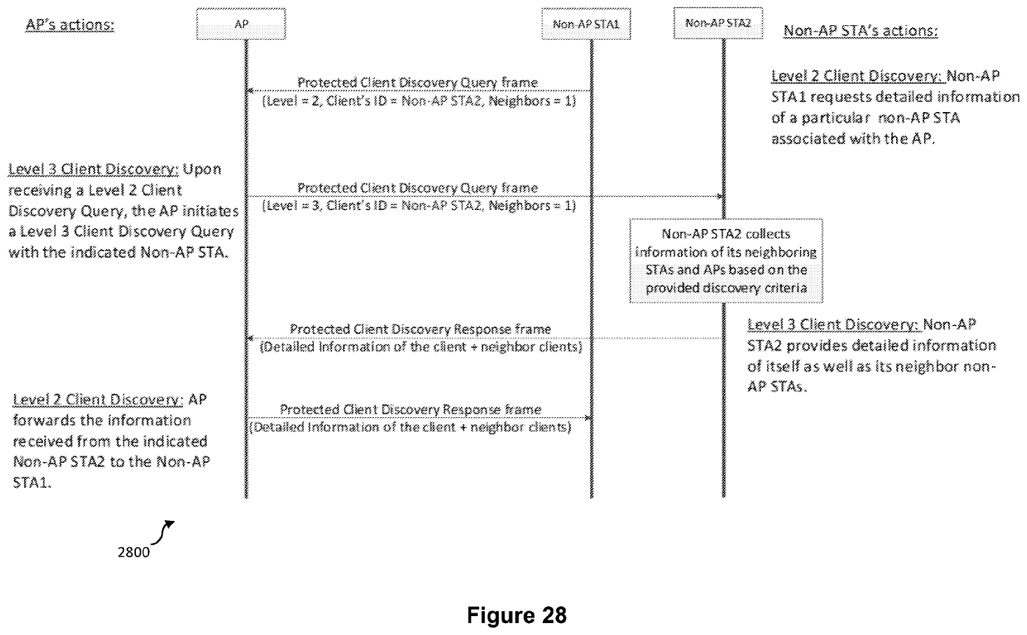

In one embodiment of the present disclosure, a Level 3 Client Discovery procedure may be triggered by an AP, for example, upon receiving a Level 2 Client Discovery Query from an associated non-AP STA) to discover neighboring non-AP STAs of an associated non-AP STA. FIG. 28 shows a flowchart 2800 illustrating a Level 3 Client Discovery procedure triggered by an AP according to an embodiment of the present disclosure. A non-AP STA1 is an SBP initiator which initiates a Level 2 Client Discovery Query and requests for detailed information of a particular non-AP STA (in this case, non-AP STA2) associated with the AP, by transmitting a Protected Client Discovery Query frame to the AP. The Protected Client Discovery Query frame comprises a level field set to 2 (or Client Discovery Mode set to 1) to indicate a Level 2 Client Discovery, a target client's ID (i.e., the Target MAC Address field) set as the ID (MAC Address) of non-AP STA2, and a Neighbors Info Requested field set to 1 to indicate that the information of the neighboring clients (i.e., STAs and APs located within a radio range) of the indicated STA is also requested. The AP, upon receiving the Level 2 Client Discovery Query, then initiates a Level 3 Client Discovery Query with the indicated non-AP STA (non-AP STA2) by transmitting a Protected Client Discovery Query frame to the indicated non-AP STA2. The Protected Client Discovery Query frame comprises a level field set to 3 (or Client Discovery Mode field set to 2) to indicate a Level 3 Client Discovery, a Target STA Info Present field set to 1 and the Neighboring Info Requested field is set to 1. The Discovery Criteria included in the Level 2 Client Discovery Query frame transmitted by the non-AP STA1 will also be included in the Level 3 Client Discovery Query frame.

The non-AP STA2, upon receiving the Level 3 Client Discovery Query frame, collects information of its neighboring STAs and APs based on the provided discovery criteria and then transmits a Protected Client Discovery Response frame to provide detailed information of the non-AP STA2 as well as its neighboring clients (e.g., non-AP STAs and APs) to the AP. The AP then forwards the information received from the indicated non-AP STA2 to the non-AP STA1.

The format and content of the Protected Client Discovery Query frame and the Protected Client Discovery Response frame for Level 3 Client Discovery is the same as that used for Client 2 Client Discovery as illustrated in FIGS. 24-27, except that for Level 3, the Client Discovery mode field is set to 2 (instead of 1) and the frames are transmitted in the reverse direction (i.e., from the Query is from AP to non-AP STA while the Response is from non-AP STA to AP).

A non-AP STA may collect information of its neighboring non-AP STAs and APs in a variety of ways. In one way, it may passively listen to frames transmitted by its neighboring non-AP STAs and APs and record its details (MAC Address from the TA field, observed RSSI/RCPI, BSSID from the BSSID field etc.). In another way, it may actively attempt frame exchanges with its neighbor non-AP STAs and APs, e.g., (i) by transmitting TDLS Discovery Request frames (via the associated AP) to them and recording the details (MAC Address from the TA field, observed RSSI/RCPI, associated AP from the BSSID field etc.) from the TDLS Discovery Response frames received on the direct link; (ii) by exchanging ANQP Request/Response frames (Group Address GAS Request/Response frames) with neighbor non-AP STAs over the direct path and recording the details (MAC Address from the TA field, observed RSSI/RCPI, BSSID from the BSSID field etc.); or (iii) by exchanging Probe Request/Response frames with neighbor APs and recording the details (MAC Address from the TA field, observed RSSI/RCPI, BSSID from the BSSID field etc.).

Such Level 3 Client Discovery may also be triggered by an AP MLD. It is similar to that for non-MLD except that the requested non-AP MLD collects information of neighboring STAs, APs for all the affiliated STAs associated with the APs listed in the BSSID List field of the Client Discovery Request element as well as information of neighbor non-AP MLDs and AP MLDs. For neighbor MLDs, in addition, the non-AP MLD also gathers MLD related information e.g., MLD MAC Addresses.

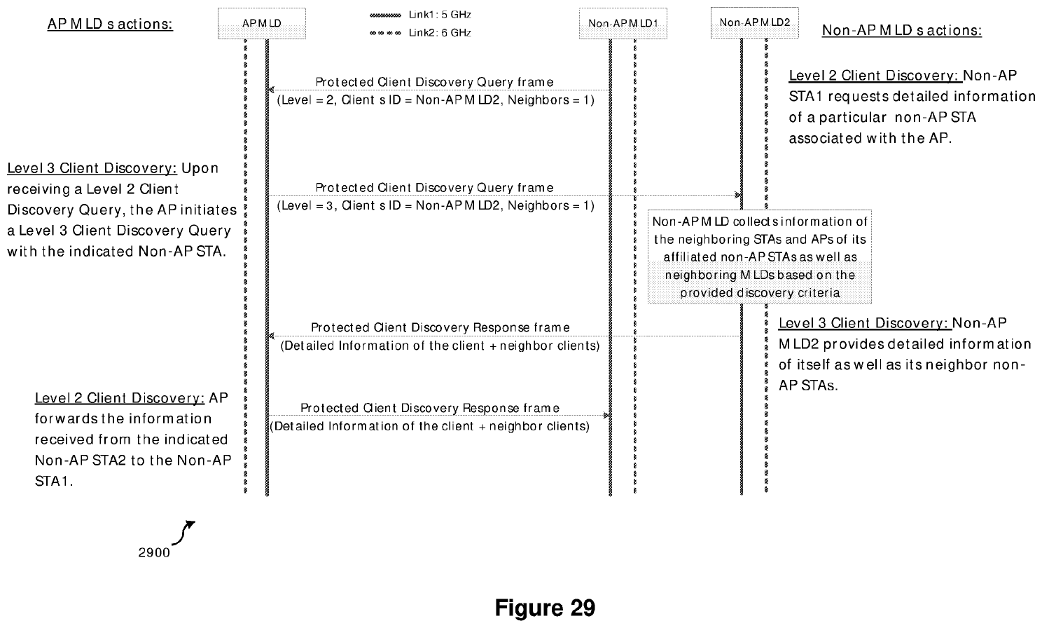

FIG. 29 shows a flowchart 2900 illustrating a Level 3 Client Discovery procedure triggered by an AP MLD according to an embodiment of the present disclosure. A non-AP MLD or its affiliated STA is an SBP initiator which initiates a Level 2 Client Discovery Query and requests for detailed information of a particular non-AP STA (in this case, a non-AP STA affiliated with non-AP MLD2) associated with the AP by transmitting a Protected Client Discovery Query frame to the AP MLD. The Protected Client Discovery Query frame comprises a level field set to 2 (or Client Discovery Mode field set to 1) to indicate a Level 2 Client Discovery, a client's ID set to that of non-AP MLD2 and a Neighbors Info Requested field set to 1 to indicate that the information of the neighboring client of the indicated STA is also requested. The AP MLD, upon receiving the Level 2 Client Discovery Query, then initiates a Level 3 Client Discovery Query with the indicated non-AP MLD (non-AP MLD2) by transmitting a Protected Client Discovery Query frame to the indicated non-AP MLD2. The Protected Client Discovery Query frame comprises a level field set to 3 (or Client Discovery Mode field set to 2) to indicate a Level 3 Client Discovery, a Target STA Info Present field set to 1 and the Neighboring Info Requested field is set to 1. The Discovery Criteria included in the Level 2 Client Discovery Query frame transmitted by the non-AP MLD1 will also be included in the Level 3 Client Discovery Query frame.

The non-AP MLD2, upon receiving the Level 3 Client Discovery Query frame, collects information of neighboring STAs and APs of its affiliated non-AP STAs and neighboring MLDs based on the provided discovery criteria and then transmits a Protected Client Discovery Response frame to provide detailed information of the non-AP STA2 as well as its neighboring clients (e.g., MLDs, non-AP STAs and APs) to the AP MLD. The AP MLD then forwards the information received from the indicated non-AP MLD2 to the non-AP MLD1.

In the following paragraphs, a second embodiment of the present disclosure, where an enhanced client discovery procedure is carried out when an AP or AP MLD is part of a Multi-AP network, is described.

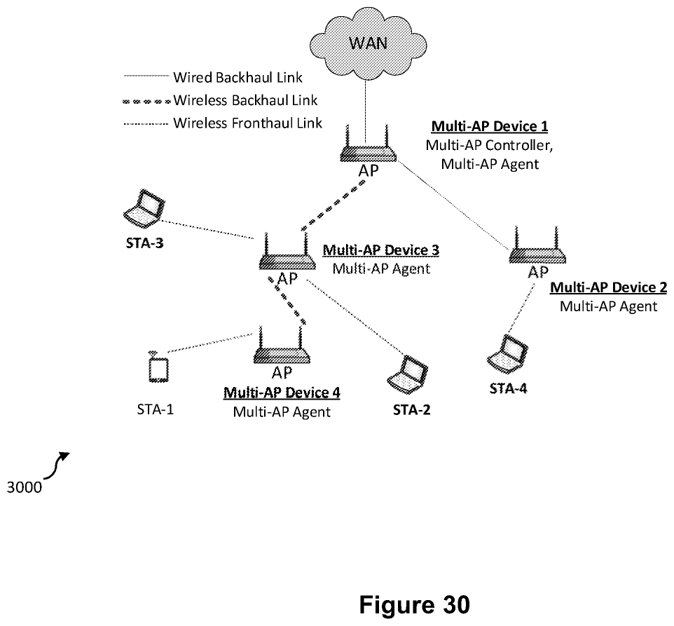

FIG. 30 shows a schematic diagram 3000 illustrating a multi-AP network deployment according to a second embodiment of the present disclosure. If an AP or AP MLD is part of a Multi-AP network (e.g., EasyMesh), a non-AP STA or non-AP MLD may also request for information of non-AP STAs associated with other APs (standalone or affiliated with AP MLDs) of the Multi-AP network as well as any unassociated non-AP STAs that the AP(s) is (are) aware of.

The format and content of Protected Client Discovery Query frames and Protected Client Discovery Response frames are the same as the first embodiment and those illustrated in FIGS. 18 and 21-27. The list of requested APs is provided in the BSSID List field. Upon receipt of a Client Discovery Query frame by an AP or AP MLD within a Multi-AP network, the AP or AP MLD can provide information of non-AP STAs and non-AP MLDs associated with other APs or AP MLDs of the Multi-AP Network.

In the following paragraphs, a third embodiment of the present disclosure, where an enhanced client discovery procedure is carried out using data frames is described.

It is possible that an AP does not support an Enhanced Client Discovery. In such as case, a non-AP STA (or a non-AP MLD) may directly solicit information from a target non-AP STA (or non-AP MLD), similar to level 2 Client Discovery, by exchanging the Client Discovery frame and Authorization Validation frames, encapsulating them in an Enhanced Client Discovery Ethertype 89-0d Data frames and getting the common associated AP to forward them to the target non-AP STA. By encapsulating the Discovery frames and Authorization Validation frames in the data frames, the AP does not require to decode the message. The decode of the frames will be carried out by the target non-AP STA (or non-AP MLD). This process may be called as Tunneled Discovery or Tunneled Enhance d Client Discovery.

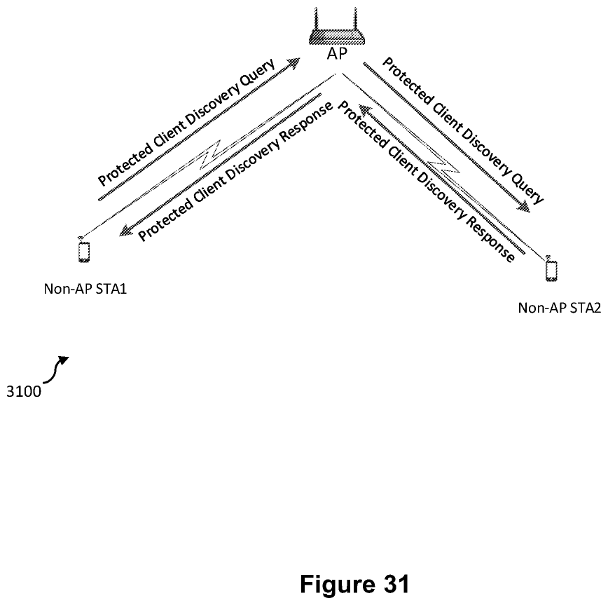

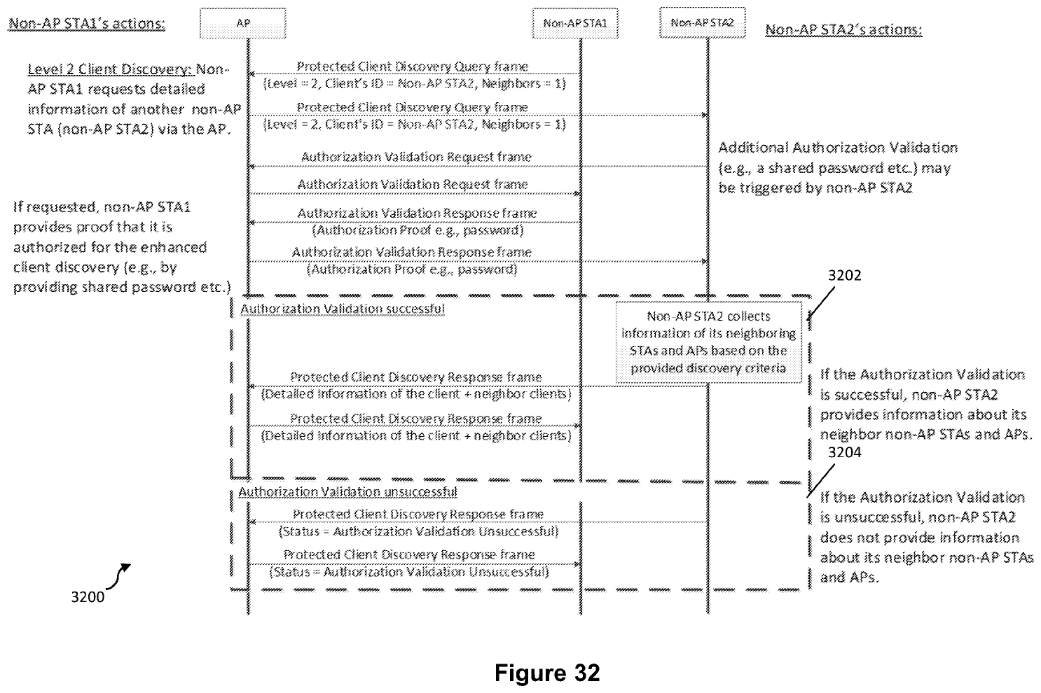

FIG. 31 shows a schematic diagram 3100 illustrating a tunneled enhanced client discovery procedure according to the third embodiment of the present disclosure. FIG. 32 shows a flowchart 3200 illustrating a tunneled enhanced client discovery procedure between a non-AP STA1 and non-AP STA2 according to the third embodiment of the present disclosure. The non-AP STA1 may first transmit a Protected Client Discovery Query frame to request information of another non-AP STA (e.g., non-AP STA2) via an AP. The Protected Client Discovery Query frame has a level field set to 2 (or Client Discovery Mode field set to 1) to indicate a level 2 Discovery Query, a client's ID set to that of non-AP STA2 and a Neighbors Info Requested field set to 1 to indicate that the information of the neighboring client's (i.e., STAs and APs located within a radio range) of the indicated STA is also requested. According to this third embodiment, the Client Discovery Query frame is encapsulated in a data frame. The AP, which receives the data frame addressed to non-AP STA2, will forward the data frame comprising the Client Discovery Query frame to the non-AP STA2 directly.

In one example, additional authorization validation may be triggered by non-AP STA2. The non-AP STA2 may then transmits an Authorization Validation Request frame to request for verification information or authorization proof (e.g., a shared password, etc.) back to non-AP STA1 via the AP. The non-AP STA1 in response transmits an Authorization Validation Response frame to provide the verification information or authorization proof (e.g., password) that it is authorized to perform the enhanced client discovery to the non-AP STA2 via the AP. Similarly, the Authorization Validation frames are encapsulated in data frames and the AP which receives the data frames will forward to the addressees and facilitates the exchanges of the Validation frames accordingly.

If the Authorization Validation is successful, steps shown in block 3202 are carried out; otherwise step shown in block 3204 is carried out. In particular, if the Authorization Validation is successful, the non-AP STA2 then collects information of its neighboring STAs and APs based on the discovery criteria provided in the Client Discovery Query frame and transmits a Protected Client Discovery Response frame comprising detailed information of the non-AP STA2 and its neighboring STAs and APs to the non-AP STA1 via the AP.

If the Authorization Validation is unsuccessful, the non-AP STA2 does not provide information about itself and its neighboring devices, but instead will transmit a Protected Client Discovery Response frame with a status field indicating that the Authorization Validation was unsuccessful back to the non-AP STA1 via the AP.

A similar frame exchange sequence can be carried out between two non-AP MLDs to achieve the same enhanced client discovery procedure except that the associated AP-MLD may forward the frames to the peer non-AP MLD on any available link (i.e., a link other than the original link use by the transmitting non-AP MLD).

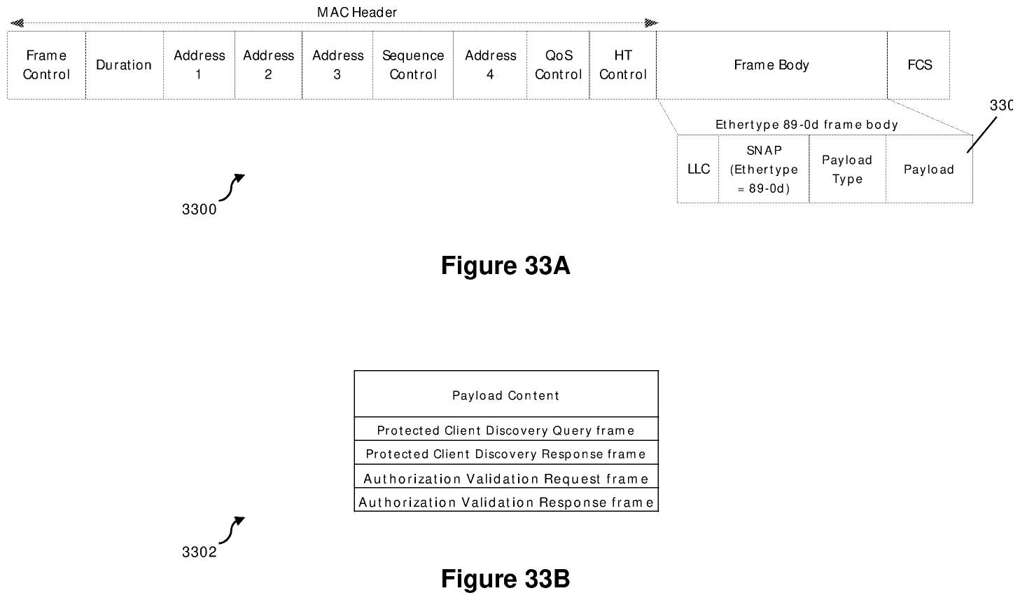

A new Ethertype 89-0d Payload Type is defined to encapsulate the Enhanced Client Discovery frames. FIG. 33A shows an example format of an Enhanced Client Discovery Ethertype 89-0d Data frame 3300 according to the third embodiment of the present disclosure. The Enhanced Client Discovery Ethertype 89-0d Data frame comprises a Frame Control field, a Duration field, three Addresses fields (Address field 1, Address field 2, Address field 3), a Sequence Control field, an Address 4 field, a Quality of Service (QOS) Control field, a HT Control field, a frame body and a FCS field. The Frame Control field, the Duration field, the three Addresses fields (Address field 1, Address field 2, Address field 3), the Sequence Control field, the Address field 4 field, the Quality of Service (QOS) Control field and the HT Control field may be grouped as MAC Header. The Address 3 (A3) field will be set as per 802.11 source address (SA) and destination (DA). More particularly, when the data frame 3300 is transmitted by a non-AP STA, the A3 field is set as the DA (MAC Address of the target non-AP STA) and when the data frame 3300 is transmitted by an AP, the A3 field is set as the SA (MAC Address of the source non-AP STA).

The Frame Body comprises a Logical Link Control (LLC) field, a SNAP field which is set to “Ethertype under 89-0d type), a Payload Type field and a Payload field 3202. The Payload Type field is set to “Enhanced Client Discovery”, e.g., Payload Type field value 5, according to table 2.

Table 2 shows various protocols corresponding Payload Type field values.

| Payload type | Protocol name |
|---|---|
| 1 | Remote Request/Response |
| 2 | TDLS |
| 3 | FST (Fast Sessions Transfer) |
| 4 | RLQP (Registered Location Query Protocol) |
| 5 | Enhanced Client Discovery |
| 6-255 | Reserved |

When the Client Discovery frames are encapsulated in the Enhanced Client Discovery Ethertype 89-0d Data frames, the frame body of the Protected Client Discovery frames and the Authorized Validation frames are carried in the Payload field of the Ethertype 89-0d Data frames.

FIG. 33B shows an example content of the Payload field 3302 illustrated in FIG. 33A according to the embodiment. The Payload field in the frame body contains a Protected Client Discovery Query frame, a Protected Discovery Response frame, an Authorized Validation Request frame and/or an Authorization Validation Response frame.

In the following paragraphs, a fourth embodiment of the present disclosure, where an enhanced client discovery procedure is carried out using higher layer protocols is described.

Instead of using Ethertype 89-0d Data frames, higher layer protocols such as 1905 Topology Query/Response message may be used for Enhanced Client Discovery. A muti-AP deployment illustrated in FIG. 30, for example EasyMesh but not limited to EasyMesh, can be taken as an example.

In a typical EasyMesh Multi-AP deployment an AP (especially the AP that is part of the multi-AP Controller) may already have access to information about all non-AP STAs that are associated with any of the APs that are part of the Multi-AP network) and even some non-AP STAs that are not associated with any of the APs.

To perform enhanced client discovery, a non-AP STA (either associated or unassociated) or an AP sends a 1905 Topology Query message carrying a Client Discovery Query Type-Length-Value (TLV) to any of the APs that are part of the Multi-AP network or to another non-AP STA to solicit information about non-AP STAs. An example format of a Client Discovery Query TLV is shown in Table 3.

Upon receipt of the Client Discovery Query TLV, the AP (or non-AP STA) provides the solicited information about non-AP STAs in a 1905 Topology Response message carrying a Client Discovery Response TLV. An example format of a Client Discovery Response TLV is shown in Table 4.

Additionally, an AP may send a 1905 Topology Query message carrying an Authorization Validation Request TLV to a non-AP STA to request for validation information and verify if the requesting non-AP STA is authorized to obtain information about other non-AP STAs. An example format of an Authorization Validation Request TLV is shown in Table 4.

Upon receipt of the Authorization Validation Request TLV from its associated AP or AP MLD, a non-AP STA may send a 1905 Topology Query message carrying an Authorization Validation Response TLV carrying the validation information (e.g., a shared password) in the format requested by the AP. An example format of an Authorization Validation Response TLV is shown in Table 5.

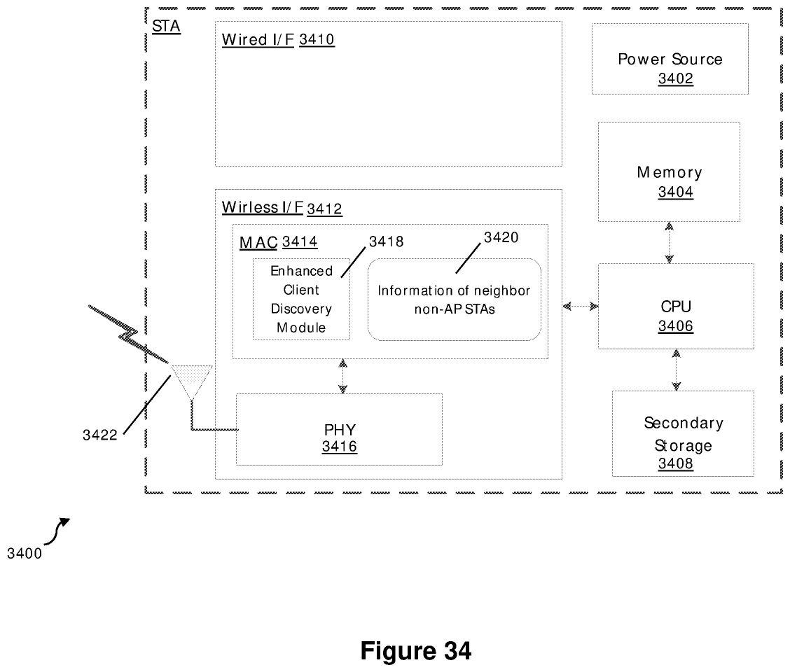

FIG. 34 shows an example configuration of a communication apparatus 3400. The communication apparatus 3400 is implemented as a non-AP STA for enhanced client discovery in accordance with various embodiments of the present disclosure. The communication apparatus 3400 comprises a power source 3402, a memory 3404, a central processing unit (CPU) 3406 comprising at least one process, a secondary storage 3408, a wired interface (I/F) 3410 and a wireless I/F 3412. The memory 3404 may be a non-transitory computer-readable storage medium having stored therein data representing instructions executable by the at least one processor of the CPU 3406 to communicate with the wireless I/F 3412 to perform enhanced client discovery procedure according to various embodiments described in the present disclosure. The Wireless I/F 3412 comprises a MAC layer 3414 and a PHY layer 3416. The PHY layer 3416 connects with a radio transmitter (not shown), a radio receiver (not shown) and an antenna 3422 used for transmitting/receiving signals to/from other communication apparatuses (e.g., STAs). Alternatively, the communication apparatus 3400 may transmit/receive signals to/from other communication apparatus (e.g., STAs) via the Wired I/F 3410. The secondary storage 3408 may be configured to store AIDs of associated communication apparatus.

The MAC layer 3414 further comprises an Enhanced Client Discovery Module 3418 and stores information of neighboring non-AP STAs 3420. The communication apparatus 3400 may be a non-AP STA, and the Enhanced Client Discovery Module 3418 may be configured to generate and process frames (e.g., client discovery query/response frames, authorization validation request/response frames) to perform enhanced client discovery procedure according to various embodiments described above. The communication apparatus 3400 may be a sensing responder, and the Enhanced Client Discovery Module 3418 may be configured to generate and process frames (e.g., client discovery query/response frames, authorization validation request/response frames) as well as provide the information of its neighboring non-AP STAs 3420 in response to a frame receipt from other communication apparatus.

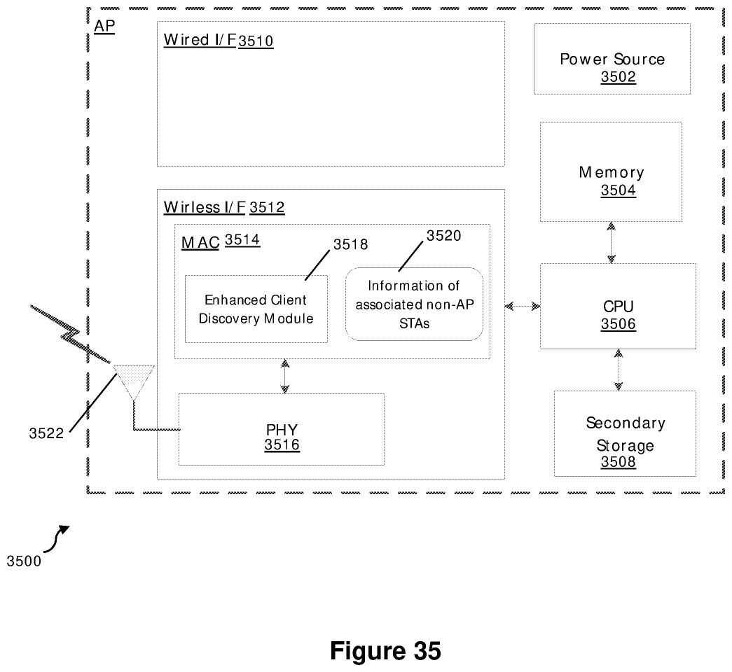

FIG. 35 shows another example configuration of a communication apparatus 3500. The communication apparatus 3500 is implemented as an AP for enhanced client discovery in accordance with the present disclosure. The communication apparatus 3500 comprises a power source 3502, a memory 3504, a central processing unit (CPU) 3506 comprising at least one processor, a secondary storage 3508, a wired I/F 3510 and a wireless I/F 3512. The memory 3504 may be a non-transitory computer-readable storage medium having stored therein data representing instructions executable by the at least one processor of the CPU 3506 to communicate with the wireless I/F 3512 to perform multi-generation random access according to various embodiments in the present disclosure. The Wireless I/F 3512 comprises a MAC layer 3514 and a PHY layer 3516. The PHY layer 3516 connects with a radio transmitter (not shown), a radio receiver (not shown) and an antenna 3522 used for transmitting/receiving signals to/from other (base) communication apparatuses. Alternatively, the communication apparatus 3500 may transmit/receive signals to/from other communication apparatus via the Wired I/F 3510.

The MAC layer 3514 further comprises an Enhanced Client Discovery Module 3518 and stores information of associated non-AP STAs 3520. The Enhanced Client Discovery Module 3518 may be configured to generate and process frames (e.g., client discovery query/response frames, authorization validation request/response frames), utilize the information of associated non-AP STAs 3520 to perform enhanced client discovery procedure according to various embodiments described above.

As described above, the embodiments of the present disclosure provide an advanced communication system, communication methods and communication apparatuses for enhanced client discovery procedure in MIMO WLAN networks.

The present disclosure can be realized by software, hardware, or software in cooperation with hardware. Each functional block used in the description of each embodiment described above can be partly or entirely realized by a large scale integration (LSI) such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

Table 3 shows an example format of a Client Discovery Query TLV used for Enhanced Client Discovery according to the fourth embodiment of the present disclosure.

| Field/Name | Length | Value | Description |
|---|---|---|---|
| tlvType | 1 octet | 0xB3 | Client Discovery |
| | | | Query TLV |
| tlvLength | 2 octets | 1 | Number of Octets |
| | | | in ensuing field |
| tlvValue | | | |
| Client | 1 octet | 0x00: Reserved | Indicates the Level |
| Discovery | | 0x01: Level 1 Client Discovery | of the client |
| Mode | | 0x02: Level 2 Client Discovery | discovery mode |
| | | 0x03: Level 3 Client Discovery | |
| | | 0x04~0xFF Reserved | |
| Client | Variable | As described in FIG. 18 | Carries the content |
| Discovery | | | of the Client Discovery |
| Request | | | Request element except |
| Information | | | the Element ID, Length |
| | | | and Element ID |
| | | | Extension fields |

Table 4 shows an example format of a Client Discovery Response TLV used for Enhanced Client Discovery according to the fourth embodiment of the present disclosure.

| Field/Name | Length | Value | Description |
|---|---|---|---|
| tlvType | 1 octet | 0xB3 | Client Discovery Query TLV |
| tlvLength | 2 octets | Variable | Number of Octets in ensuing field |
| tlvValue | | | |
| Client | 1 octet | 0x00: Reserved | A 1905 device that receives a Multi- |
| Discovery | | 0x01: Level 1 Client | AP Profile TLV with a reserved value |
| Mode | | Discovery | shall assume the sender implements |
| | | 0x02: Level 2 Client | the same profile implemented by the |
| | | Discovery | receiver |
| | | 0x03: Level 3 Client | |
| | | Discovery | |
| | | 0x04~0xFF Reserved | |
| Client | 1 octet | Variable | Number of Octets in the Client |
| Information | | | Information field |
| Length | | | |
| Client | Variable | As described in FIGS. | Carries the content of the Client |
| Information | | 21 and 22 | Information element except the |
| | | | Element ID, Length and Element ID |
| | | | Extension fields |
| MLD | 1 octet | Variable | Number of Octets in the MLD |
| Information | | | Information field |
| Length | | | |
| MLD | Variable | As described in FIGS. | Carries the content of the MLD |
| Information | | 21 and 22 | Information element except the |
| | | | Element ID, Length and Element ID |
| | | | Extension fields |
| Client | 1 octet | Variable | Number of Octets in the Client |
| Information ML | | | Information ML field |
| Length | | | |
| Client | Variable | As described in Client | Carries the content of the Client |
| Information ML | | Information ML | Information ML element except the |
| | | element (E1) | Element ID, Length and Element ID |
| | | | Extension fields (E1). |

Table 5 shows an example format of an Authorization Validation Request TLV used for Enhanced Client Discovery according to the fourth embodiment of the present disclosure.

| Field/Name | Length | Value | Description |
|---|---|---|---|
| tlvType | 1 octet | 0xB3 | Client Discovery |
| | | | Query TLV |
| tlvLength | 2 octets | 1 | Number of Octets |
| | | | in ensuing field |
| tlvValue | | | |
| Validation | 1 octet | 0x00: Reserved | Indicates the |
| Mode | | 0x01: Plaintext Password | validation mode. |
| | | 0x02: Hashed Password | |
| | | 0x03~0xFF Reserved | |

Table 6 shows an example format of an Authorization Validation Response TLV used for Enhanced Client Discovery according to the fourth embodiment of the present disclosure.

| Field/Name | Length | Value | Description |
|---|---|---|---|
| tlvType | 1 octet | 0xB3 | Client Discovery |
| | | | Query TLV. |
| tlvLength | 2 octets | Variable | Number of Octets |
| | | | in ensuing field. |
| tlvValue | | | |
| Validation | 1 octet | 0x00: Reserved | Indicates the |
| Mode | | 0x01: Plaintext Password | validation mode. |
| | | 0x02: Hashed Password | |
| | | 0x03~0xFF Reserved | |
| Validation | 1 octet | Variable | Length of the |
| Information | | | Validation |
| Length | | | Information field |
| Validation | Variable | | Carries the Plaintext |
| Information | | | Password or Hashed |
| | | | Password based on |
| | | | the Validation |
| | | | Mode field. |

1. A first communication apparatus comprising:
circuitry, which, in operation, is configured to generate a first frame;
a transmitter, which, in operation, transmits the first frame to a second communication apparatus to request for information of a third communication apparatus.

2. The first communication apparatuses of claim 1, wherein the information comprises information of one or more neighboring communication apparatuses of the third communication apparatus.

3. The first communication apparatus of claim 1, wherein the information comprises at least one of a media access control (MAC) address, an associated identifier (AID), an identifier of an associated access point (AP), a supported capability, a physical (PHY) version, an operating channel width and a location of either or both of the third communication apparatus and a neighboring communication apparatus of the third communication apparatus.

4. The first communication apparatus of claim 1, wherein the first frame comprises a field indicating a condition for selecting the third communication apparatus, and the condition is at least one of a supported capability, a PHY version, an operating channel width, a link quality indicator and an associated AP of the third communication apparatus.

5. The first communication apparatus of claim 1, wherein the third communication apparatus is one of a plurality of third communication apparatuses and the circuitry is configured to further generate a second frame and the transmitter transmits the second frame to request for information of the plurality of third communication apparatuses.

6. The first communication apparatus of claim 5, wherein the request of the first frame and/or the request of the second frame is encapsulated in a data frame.

7. The first communication apparatus of claim 6, wherein the data frame comprises an Ethertype 89-0d data frame.

8. The first communication apparatus of claim 1, further comprising:
a receiver, which, in operation, receives a validation request frame to request for verification information indicating that the first communication apparatus is authorized to obtain the information of the third communication apparatus, wherein the circuitry is configured to process the validation request frame and generate a validation response frame comprising the verification information, and the transmitter transmits the validation response frame.

9. The first communication apparatus of claim 1, wherein the first communication apparatus and the third communication apparatus are non-access-point (non-AP) stations and the second communication apparatus is an access point.

10. The first communication apparatus of claim 9, wherein the first communication apparatus and the third communication apparatus are not associated with the second communication apparatus.

11. The first communication apparatus of claim 9, wherein the first communication apparatus is affiliated with a non-AP multi-link device (MLD) and the second communication apparatus is affiliated with an AP MLD.

12. A second communication apparatus comprising:
a receiver, which, in operation, receives a request frame from a first communication apparatus requesting for information of a third communication apparatus;
circuitry, which, in operation, is configured to process the request frame and generate a response frame comprising the information; and
a transmitter, which in operation, transmits the response frame to the first communication apparatus.

13. The second communication apparatuses of claim 12, wherein the information comprises information of one or more neighboring communication apparatuses of the third communication apparatus.

14. The second communication apparatus of claim 13, wherein the request frame further requests the third communication apparatus to collect and report the information of the one or more neighboring communication apparatuses, and the circuitry generates the response frame comprising the information of the one or more neighboring communication apparatuses collected and reported by the third communication apparatus.

15. The second communication apparatus of claim 12, wherein the circuitry further generates a validation request frame to request for verification information indicating that the first communication apparatus is authorized to obtain the information of the third communication apparatus, wherein the receiver further receives a validation response frame comprising the verification information from the first communication apparatus.

16. The second communication apparatus of claim 12, wherein the first communication apparatus and the third communication apparatus are non-access-point (non-AP) stations and the second communication apparatus is an access point.

17. The second communication apparatus of claim 16, wherein the first communication apparatus and the third communication apparatus are not associated with the second communication apparatus.

18. The second communication apparatus of claim 16, wherein the first communication apparatus is affiliated with a non-AP MLD and the second communication apparatus is affiliated with an AP MLD.

19. A communication method implemented by a first communication apparatus comprising:
generating a first frame; and
transmitting the first frame to a second communication apparatus to request for information of a third communication apparatus.

20. A communication method implemented by a second communication apparatus comprising:
receiving a request frame from a first communication apparatus requesting for information of a third communication apparatus;
processing the request frame;
generating a response frame comprising the information; and
transmitting the response frame to the first communication apparatus.
